(19) United States
(12) Patent Application Publication
(10) Pub. No.: US 2024/0002672 A1
(43) Pub. Date: Jan. 4, 2024

(54) SPACECRAFT, COATING AND METHOD

(71) Applicant: The University of Manchester, Manchester, Greater Manchester (GB)

(72) Inventors: Peter Roberts, Manchester, Greater Manchester (GB); Steve Edmondson, Manchester, Greater Manchester (GB); Stephen Worrall, Manchester, Greater Manchester (GB); Vitor Oiko, Manchester, Greater Manchester (GB)

(21) Appl. No.: 18/247,491

(22) PCT Filed: Oct. 1, 2021
(86) PCT No.: PCT/EP2021/077192

§ 371 Date: Mar. 31, 2023

(30) Foreign Application Priority Data
Oct. 2, 2020 (GB) 2015642.8

(51) Int. Cl. C09D 1/00; C01B 19/00; C09D 5/44; C09D 5/08; B64G 1/22; B64G 1/52; C25D 13/02

(52) U.S. Cl. CPC C09D 1/00; C01B 19/007; C09D 5/44; C09D 5/084; B64G 1/226; B64G 1/52; C25D 13/02; C01P 2004/24; C01P 2004/64; C01P 2004/62; C01P 2006/90; C01P 2002/82; C01P 2004/04; C01P 2004/03; C01P 2002/85

(57) ABSTRACT

A spacecraft, for example a satellite, or a part thereof having a coating comprising a 2D material on an outer surface thereof is described. The 2D material comprises one or more elements, excluding C, N and S, in an amount of at least 50 at. %; and respective oxides of the one or more elements of the 2D material have a vapour pressure of at most 10 Pa at a temperature of 323 K.

### FIELD

The present invention relates to coatings for spacecraft, for example satellites such as Very Low Earth Orbit, VLEO, satellites.

### BACKGROUND TO THE INVENTION

The major hurdle to sustained operation in VLEO is the lower operational lifetime of satellites, which results from the atmosphere's greater density and higher atomic oxygen content. Specifically, the VLEO atmosphere can be up to six orders of magnitude denser than at LEO altitudes, leading to significantly increased atmospheric drag, while the VLEO atmosphere can be comprised of up to 90 at. % atomic oxygen, leading to increased erosion rates. Cost effective realization of VLEO satellites therefore relies on identifying materials with ultralow erosion rates when exposed to atomic oxygen. The majority of research to date has focused on materials that exhibit resistance to erosion by atomic oxygen whilst comparatively little effort has been expended in the search for materials with superior atomic oxygen reflection properties which can assist in reducing atmospheric drag and increasing aerodynamic lift production.

Hence, there is a need to provide materials having improved atomic oxygen erosion resistance while also having enhanced atomic oxygen reflection properties.

### SUMMARY OF THE INVENTION

It is one aim of the present invention, amongst others, to provide a spacecraft which at least partially obviates or mitigates at least some of the disadvantages of the prior art, whether identified herein or elsewhere. For instance, it is an aim of embodiments of the invention to provide a coating for a spacecraft having improved atomic oxygen erosion resistance while also having enhanced atomic oxygen reflection properties. For instance, it is an aim of embodiments of the invention to provide a method of providing a coating for a spacecraft having improved atomic oxygen erosion resistance while also having enhanced atomic oxygen reflection properties.

A first aspect provides a spacecraft, for example a satellite, or a part thereof having a coating comprising a 2D material on an outer surface thereof,
wherein the 2D material comprises one or more elements, excluding C, N and S, in an amount of at least 50 at. %; and
wherein respective oxides of the one or more elements of the 2D material have a vapour pressure of at most 10 Pa at a temperature of 323 K.

A second aspect provides a 2D material, a coating comprising a 2D material or a coating comprising a 2D material on a substrate, wherein the 2D material is according to the first aspect.

A third aspect provides a method of protecting, at least in part, a spacecraft, for example a satellite such as a Very Low Earth Orbit, VLEO, satellite, or a part thereof according to the first aspect, the method comprising:
exposing the coating to atomic oxygen incident thereupon, reacting the one or more elements of the 2D material with the atomic oxygen and producing respective oxides of the one or more elements.

A fourth aspect provides a method of providing a coating on a substrate for a spacecraft, for example a satellite, or a part thereof, the method comprising:
providing a 2D material by liquid phase exfoliation, LPE; and
depositing the 2D material on the substrate by electrophoretic deposition, EPD, thereby providing the coating on the substrate;
optionally wherein the 2D material is a transition metal dichalcogenide, TMD, having a chemical formula MX₂, wherein M is a transition metal, preferably a second row or a third row transition metal, and X is a chalcogen.

A fifth aspect provides use of a 2D transition metal dichalcogenide, TMD, preferably MoSe₂ or WSe₂, as an atomic oxygen erosion-resistant coating on a Very Low Earth Orbit, VLEO, satellite or a part thereof.

### DETAILED DESCRIPTION OF THE INVENTION

According to the present invention there is provided a spacecraft or a part thereof, as set forth in the appended claims. Also provided is a 2D material, a coating comprising a 2D material, a coating comprising a 2D material on a substrate, a method of protecting a spacecraft, a method of providing a coating and a use of a 2D material. Other features of the invention will be apparent from the dependent claims, and the description that follows.

The first aspect provides a spacecraft, for example a satellite, or a part thereof having a coating comprising a 2D material on an outer surface thereof;
wherein the 2D material comprises one or more elements, excluding C, N and S, in an amount of at least 50 at. %; and
wherein respective oxides of the one or more elements of the 2D material have a vapour pressure of at most 10 Pa at a temperature of 323 K.

In this way, the coating provides excellent atomic oxygen reflection properties, due at least in part to the 2D material, while improved atomic oxygen erosion resistance, compared with conventional 2D materials such as graphene, is provided by self-passivation, since the respective oxides of the one or more elements of the 2D material have a vapour pressure of at most 10 Pa at a temperature of 323 K. In other words, the 2D material is substantially atomically flat, thereby providing excellent atomic oxygen reflection properties (Effects of Surface Disorder, Various Surface Structures of Chemisorbed Gases and Carbon on Helium Atomic Beam Scattering from the (100) Surface of Platinum, L. A. West, and G. A. Somorjai, J. Chem. Phys. 54, 2864 (1971); https://doi.org/10.1063/1.1675266; Ballistic molecular transport through two dimensional channels, A. Keerthi, A. K. Geim, A. Janardanan, A. P. Rooney, A. Esfandiar, S. Hu, S. A. Dar, I. V. Grigorieva, S. J. Haigh, F. C. Wang & B. Radha, Nature, Vol. 558, 420, https://doi.org/10.1038/s41586-018-0203-2; Space irradiation-induced damage to graphene films, Liping Wang, Xiaoqiang Fan, Wen Li, Hao Li, Minhao Zhu, Jibin Pu and Qunji Xue, Nanoscale, 2017, 9, 13079, https://doi.org/10.1039/c7nr04863g; incorporated by reference herein in entirety). However, the oxide products of oxidation by atomic oxygen of the one or more elements are solid, thereby providing improved atomic oxygen erosion resistance since the 2D material is not vaporised in use upon oxidation by atomic oxygen. That is, the 2D material provides the excellent atomic oxygen reflection properties of, for example graphene, while having improved atomic oxygen erosion resistance compared therewith.

Very Low Earth Orbit

VLEO is the orbital altitude range where aerodynamic effects have a significant impact on space system design that begins at the Karman line, the boundary between the Earth's atmosphere and space, defined as 100 km above sea level, and ends at approximately 450 km above sea level (FIG. 1). The two major challenges that require surmounting in order to realize sustained operation in VLEO relate to the chemical composition and density of the tenuous atmosphere the satellite will be exposed to at these altitudes.

Atmospheric Composition in VLEO

The atmosphere in VLEO is composed primarily of nitrogen and oxygen, similar to the Earth's true atmosphere below the Karman line. However, due to the high levels of UV radiation present in LEO, approximately 140 mW cm⁻², molecular oxygen O₂ is rapidly photolysed to give ground state atomic oxygen O(³P), as shown in Equation 1:

O₂(g)+hv(v<243 nm)→20(³P)(g)

As a result, O(³P) is the dominant chemical species throughout much of VLEO, comprising as much as 90% of the number density at certain altitudes (FIG. 1). Due to this proportionally high concentration, and the fact that the orbital velocity of a satellite in VLEO is on the order of 8 km s⁻¹, surfaces of the satellite that are facing into the satellite's direction of travel (the ram direction) are impacted by approximately 10¹³-10¹⁷ atoms cm⁻² s⁻¹ of O(³P). As a result, the average collision energy of an O(³P) impacting upon the satellite surface is 4.5 eV. This corresponds to an energy of around 434 kJ mol⁻¹, which is higher than many known chemical bond enthalpies. As a result, this constant bombardment will lead to significant erosion for almost all materials; oxidation reactions cause chemical bond breakage and the formation of both volatile and non-volatile oxidation products. Materials on the surfaces of satellites therefore undergo significant physical and chemical changes which have knock-on effects in terms of their micro and macro scale properties. These changes in properties can have severe negative impacts upon the function of the material and potentially lead to catastrophic failures.

Furthermore, the density of the rarefied atmosphere in VLEO can be up to six orders of magnitude greater than that at higher LEO altitudes (FIG. 1). This increased density leads to greater rates of erosion due to O(³P), but more significantly also leads to increased aerodynamic forces (principally drag) which lead to a markedly reduced operational lifetime for satellites at these altitudes. In order to make sustained satellite operation a possibility in VLEO, it is imperative that atmospheric drag is minimized.

Aerodynamic Forces in VLEO

The aerodynamics force F experienced in orbit can be defined using Equation 2:

$$F = \frac{( ϱ {v}^{2} {C}_{f} {A}_{r e f} )}{2}$$

where [symbol] is the atmospheric density, υ is the orbital velocity of the satellite, C_{f} is a dimensionless aerodynamic coefficient and A_{ref} is a corresponding reference area.

Drag is the predominant non-conservative force or non-gravitational force experienced in orbit, and acts in the opposite sense to the direction of travel, causing orbital decay and reducing the orbital lifetime. However, forces perpendicular to drag (typically termed lift and side forces; FIG. 2) can also be produced and used to perform aerodynamic attitude and orbital control manoeuvres which may be beneficial to operations in VLEO.

Atmospheric density and the orbital velocity of the satellite are principally dependent on the orbital altitude and therefore cannot be controlled. As a result, this leaves the aerodynamic coefficient and the associated reference area as the only variables that can be used to try and influence the aerodynamic forces and minimize drag.

The aerodynamic coefficients are dependent upon the orientation of the satellite, the geometry of the satellite surfaces, and the interactions between impinging gas molecules and those surfaces.

Gas-Surface Interactions in VLEO

In the altitude range of VLEO the Knudsen number Kₙ, which is the ratio between the mean free path of the gas particles and the characteristic length of the spacecraft, is much greater than 10. This means that the probability of a collision between gas molecules is so low that it can be effectively ignored thus meeting the conditions of free molecular flow and as a result the aerodynamics of the satellite are determined by gas surface interactions. There are four different mean free paths that need to be considered:
1) an incident gas particle relative to an incident gas particle;
2) an incident gas particle relative to a reflected gas particle;
3) a reflected gas particle relative to an incident gas particle; and
4) a reflected gas particle relative to a reflected gas particle.

Assuming fully diffuse reflection, the mean free path of an incident gas particle relative to a reflected gas particle is the shortest of the four different types. Therefore, the Knudsen number Kₙ derived from this mean free path needs to be much greater than 10 in order to ensure that the conditions of free molecular flow are met. If reflection is anything less than fully diffuse then it is possible that one of the other three mean paths may become the shortest in which case it would become the mean free path which would determine whether the conditions of free molecular flow were met.

As the atmosphere in VLEO is predominantly O(³P) (see FIG. 1) it is reasonable to consider just the possible interactions between atoms of diatomic molecules (i.e. molecules that are diatomic in their low energy states) and surfaces when discussing the gas surface interactions (GSI) in VLEO.

A gas atom, O(³P), which interacts with a surface can either be adsorbed onto the surface or reflected back. An O(³P) can undergo adsorption in one of two ways, either by chemisorption at an active site, O(³P)*, (Equation 3) or by physisorption elsewhere on the surface, O(³P)ᵣ (Equation 4).

O(³P)+*→O(³P)* (Equation 3)

O(³P)→O(³P)ᵣ (Equation 4)

O(³P) that undergoes chemisorption is irreversibly bound to the surface, but the physisorbed O(³P) can undergo desorption from the surface (Equation 5) at any time it is diffusing on the surface (Equation 6). Alternatively a physisorbed O(³P)ᵣ, undergoing surface diffusion, can encounter a vacant active site and become chemisorbed O(³P)* (Equation 7) or encounter an already chemisorbed O(3P)* and undergo a Langmuir-Hinshelwood (LH) recombination to produce O₂ and regenerate the active site (Equation 8).

O(³P)ᵣ→O(³P) (Equation 5)

O(³P)ᵣ→O(³P)ᵣ (Equation 6)

O(³P)ᵣ→O(³P)* (Equation 7)

O(³P)*+O(³P)ᵣ→O₂+* (Equation 8)

An alternative mechanism for O₂ production also exists via the Eley-Rideal (ER) recombination mechanism, where a gas phase O(³P) interacts directly with a chemisorbed O(3P)* to produce O2 and regenerate the active site (Equation 9).

O(³P)*+O(³P)→O₂+* (Equation 9)

These seven possible reaction steps describe interactions in the ideal case of a perfectly inert surface which does not undergo oxidative chemical reactions with the impinging atomic oxygen. As already discussed, this is not the case in VLEO. For real materials this is never the case and the additional material dependent reaction steps are discussed in detail in subsequent sections. In brief these can be approximated as desorption or recombination reactions where the material leaves the surface in the form of oxides (similar to Equation 5 or Equations 8 and 9, respectively, but with the surface material atomic species replacing the O(³P) or O₂ leaving the surface).

In order to reduce the drag coefficient, it is desirable to minimize the extent of all of these GSIs. The greater the interaction between the O(³P) and the surface the greater the extent of energy equilibration that will occur between the O(³P) and the surface. The greater the equilibration the lower the energy and the momentum of the average re-emitted O(³P) which leads to a more thermal (inelastic) and diffuse re-emission as opposed to elastic and specular re-emission. The two extreme cases, where every O(3P) completely equilibrates with the surface before re-emission (thermal, diffuse scattering) and where no equilibration occurs at all (elastic, specular scattering) are depicted in FIG. 2. Intermediate remission distributions are also possible depending on the character of the gas-surface interaction and have been observed in experimental studies, principally diffuse-lobal and, quasi-, sub-, and superspecular patterns.

A number of gas-surface interaction models (GSIMs) have been published in the literature, providing a simplified mathematical expression that captures the exchange of momentum that occurs at the surface and yields either the surface pressure and shear stress coefficients or corresponding lift and drag coefficients. However, these models are based on differing assumptions of the oncoming flow environment, effect of accommodation at the surface, and scattering pattern of the reflected or reemitted particles and can thus provide substantially different results when implemented.

The effect of the combination of surface geometry and the character of the re-emission on the aerodynamic coefficients is shown in FIG. 3 using the Schaaf and Chambre model, which conforms in the limiting cases to the descriptions of thermal diffuse and elastic specular reflections provided above.

In the case of complete thermal diffuse re-emission, the drag coefficient is more than an order of magnitude greater than the lift, demonstrating the qualities typically observed in the orbital environment for highly accommodated surfaces.

For complete specular reflection, the drag coefficient for incidence angles θ>45° (from the surface normal) is significantly reduced, whilst for θ<45° it is increased. Furthermore, the lift that is generated from the re-emission is shown to increase significantly over the diffuse case.

The combination of specular or quasi-specularly reflecting materials with geometric design of the external spacecraft surfaces can therefore present a range of opportunities for drag reduction and use of lift/side forces, supporting sustained operations at lower orbital altitudes and enabling novel aerodynamics-based attitude and orbital control manoeuvres.

Alternatively, specularly reflecting surfaces, when oriented towards the oncoming flow, can also be utilised to increase orbital drag with application to improved deorbit devices and avoidance of orbital debris accumulation.

The properties that determine to what extent a material will diffusely or specularly re-emit O(³P), and how this is inexorably linked to its resistance to erosion by O(³P), are discussed in the next section.

Reducing Erosion and Promoting Specular Reflection

The extent to which an impinging particle equilibrates with a satellite surface can be described by an energy accommodation coefficient α (Equation 10):

$$α = \frac{( {E}_{i} - {E}_{r} )}{( {E}_{i} - {E}_{s} )}$$

where Eᵢ is the kinetic energy of the incident particle, Eᵣ is the kinetic energy of the re-emitted particle and Eₛ is the kinetic energy the particle would have if it was re-emitted at the temperature of the surface. This equation can also be written in terms of kinetic temperatures Tₖ rather than energy E. When α=1, complete equilibration has occurred and re-emission will be thermal. As a tends towards zero re-emission becomes increasingly hyperthermal in nature as the extent of equilibration is reduced. Eᵢ is primarily dependent upon the satellite's orbital velocity, dictated by altitude, and Eₛ is dependent on the satellite's temperature so are not easily modified. In contrast, Eᵣ is determined by a whole host of surface factors that may be controlled to optimize the satellite's performance, including roughness, composition and cleanliness (extent of adsorbed contaminants) as well as the angle of incidence of the impinging particle.

Alternatively, the extent of equilibration between an impinging particle and a surface can be described by the tangential momentum accommodation coefficient (TMAC) σ and the normal momentum accommodation coefficient (NMAC) σ′ that together define the fraction of collisions that result in diffuse scattering. The TMAC σ is defined in Equation 11:

$$σ = \frac{( {p}_{x , i} - {p}_{x , f} )}{( {p}_{x , i} - {p}_{x , s} )} = \frac{( {p}_{x , i} - {p}_{x , f} )}{{p}_{x , i}}$$

where p_{x,i} is the average particle momentum tangent to the solid surface before collision, p_{x,f} is the average particle momentum tangent to the solid surface after collision and p_{x,s} is the tangential momentum a particle would carry away from the surface if reflected diffusely after full thermal equilibration.

In the case of fully diffuse thermal reflection, the probability of a particle leaving the surface with any given energy (less than the incident energy) in any given direction is the same as for any other given energy and any other given direction. Hence the tangential momentums cancel out and p_{x,s}=0. Thus, Equation 11 can be simplified as shown. The NMAC σ′ is defined in Equation 12:

$${σ}^{′} = \frac{( {p}_{y , i} - {p}_{y , f} )}{( {p}_{y , i} - {p}_{y , s} )}$$

where p_{y,i} is the average particle momentum normal to the solid surface before collision, p_{y,f} is the average particle momentum normal to the solid surface after collision and p_{y,s} is the normal momentum a particle would carry away from the surface if reflected diffusely after full thermal equilibration.

Many of the same factors that impact upon the kinetic energy of a particle after collision, Eᵣ, also impact upon its tangential momentum, p_{x,f} as the kinetic energy of a particle partly defines its velocity upon which momentum is dependent. Such properties include surface roughness and cleanliness. As a result, during our discussion we can to a reasonable approximation discuss both accommodation coefficients α and σ together.

Molecular Composition

The angular dependence of a can be modelled using Equation 13:

$$α = 3.6 ( \frac{μ}{{( 1 + μ )}^{2}} ) sin θ$$

where μ is the ratio of the molar masses of the gas molecules and the surface molecules and θ is the angle of incidence of the particle, of a given incident energy, measured from the normal.

This means that for a given surface, and a given incident particle energy, the system is furthest from equilibrium at normal incidence (θ=0) and this observation is born out experimentally. This is to be expected as the further from the normal the incident angle is the greater the length of time the particle will spend in the attractive potential regime as it approaches the surface before entering the repulsive potential regime (FIG. 4). However, the identity of the material that composes the surface also plays a key role as the higher the molar mass of the surface atoms the weaker the dependency of a on the incidence angle. This argument also implies that the accommodation coefficients also depend on the mass of the incident particle, and indeed several reports have shown that generally the lower the mass of the impinging particle the higher the accommodation coefficient. How this predicted dependency of the accommodation coefficient on molecular mass impacts upon drag and lift is shown in FIG. 5, for a number of relevant gas species, at three different incidence angles.

In practice, this trend is not always observed and other experimental studies have shown that diatomic species exhibit lower accommodation coefficients than a monoatomic species of higher mass. As this discussion is focused on only one monoatomic impinging atom species, O(³P), this effect will not be considered further. Minimizing the extent of equilibration is key in order to promote specular type reflections, thus it is desirable for satellite surfaces to be composed of higher molecular weight materials.

Nonetheless increased satellite weight is highly undesirable, so thin coatings containing high molar mass atoms or molecules (typically with high density) on a lighter material are a possible solution. Numerous examples of this will be discussed in later sections.

Surface Roughness

For certain materials, the oxidation reactions occurring with O(³P) during erosion, may increase or decrease its average molecular weight and thus impact upon its reflection properties over time. Erosion will also often lead to increases in surface roughness which will cause an increase in the extent of equilibration between O(³P) and the satellite surface and lead to increased energy and momentum accommodation coefficients and more thermal and diffuse re-emission. This is because the higher the surface roughness the greater the probability of an individual O(³P) undergoing multiple interaction events with the surface.

Surface Cleanliness

The extent of O(³P) adsorption has an important negative impact upon the aerodynamics of a satellite because the greater the O(³P) surface coverage, the greater the extent of equilibration. To understand this observation, and how the choice of material plays a key role in controlling it, the seven possible reaction steps for the interaction of O(³P) with a surface that were introduced in the previous section (Equations 3-9) must be considered.

The amount of O(3P) adsorbed on the satellite surface at any given time will be determined by the relative rates of reaction of the different possible reaction steps. These are represented schematically (FIG. 6) and summarized below for clarity (Equation 14):

Chemisorption O(³P)+*→O(³P)* A:

Physisorption O(³P)→O(³P)ᵣ B:

Desorption O(³P)ᵣ→O(³P) C;

Surface diffusion O(³P)ᵣ→O(³P)ᵣ D:

Surface diffusion to an active site O(³P)ᵣ→O(³P)* E:

LH recombination O(³P)*+O(³P)ᵣ→O₂+* F:

ER recombination O(³P)*+O(³P)→O₂+* G:

All seven steps are at least partially dependent on the molecular composition of the surface. Minimizing the rates of A, B, D and E and maximizing the rate of C will minimize the extent of O(³P) adsorbed on the surface.

In order to minimize the rate of chemisorption the surface needs to be composed of a material that has a low number of defects in its molecular structure as these are the active sites at which chemisorption can occur. Additionally, the material also needs to have a low reactivity towards O(³P), as the chemical reactions that cause erosion also generate defects. Even if a material is initially almost defect free if it undergoes oxidation by O(P) it will rapidly become highly defective which will lead to an increase in the rate of chemisorption.

The rate of physisorption is dependent on the identity of the material, as accounted for in Equation 13 where the extent of energy accommodation is shown to be inversely proportional to the molecular weight of the surface and is also inversely proportional to its temperature at a given pressure. Conversely the rate of desorption is proportional to the surface temperature at a given pressure. As a satellite surface in VLEO will go through significant temperature oscillations, between −120° C. and +120° C. and potentially even higher, the rates of physisorption and desorption will also vary significantly. This will lead to variable extents of equilibration between impinging O(³P) and thus variable O(³P) re-emission properties.

The rates of surface diffusion are proportional to the density of defects in the molecular structure and also proportional to the surface temperature. This presents a dilemma as whilst maximizing the temperature would minimize the rate of physisorption and maximize the rate of desorption, which is desirable, it would maximize surface diffusion which is undesirable.

Minimizing the rate of surface diffusion reduces the surface coverage of O(³P) as it reduces the likelihood of a physisorbed O(³P) becoming a chemisorbed O(³P). Whilst physisorbed O(³P) can undergo desorption without equilibrating with the surface significantly, chemisorbed O(³P) can only be removed from the surface via recombination with a physisorbed O(³P) to produce O₂ or via erosion of the surface material to produce a volatile oxide. In both cases significant equilibration with the surface will have occurred. This means that the rates of LH and ER recombination are dependent on the rates of adsorption, desorption and surface diffusion of O(³P). Consequently, measurements of the rate at which O₂ is formed from a surface under a given set of conditions indicates the extent to which O(³P) equilibrates with that surface and the amount of specular or diffuse re-emission O(³P).

Atomic Recombination Cross-Sections—Proxies for Atomic Reflection Properties

The metric most commonly used to compare the rates of O(³P) recombination for various surfaces is their recombination cross section, which is the ratio between the number of O(³P) that recombine on a surface and the total number of O(³P) that strike that surface. These values can vary over many orders of magnitude with silica-based materials, particularly Pyrex, often exhibiting the lowest values on the order of 10⁻⁵.

It is important to note here that just because a material is resistant to atomic oxygen it does not necessarily mean that it will have a low O(³P) recombination cross section. For example, Au is well known to be resistant to oxidation, whilst Mg oxidises easily, yet they possess similar O(3P) recombination cross sections. It is also important to note that these values depend upon the surface area/roughness of the material and that is not usually accounted for, with the naturally smooth glass surface of Pyrex one suggested reason for its notably low O(³P) recombination cross section.

Recombination cross sections have also been shown to depend upon the structural detail of the material; with different types of silica observed to possess significantly different O(³P) recombination cross sections.

It is not known whether this is due to differing extents of crystallinity, different crystal structures or differing defect densities/impurities. It is likely that all play a role but a number of modelling studies which have attempted to investigate, understand and explain these effects have identified defect density and type to potentially be the most significant. O(³P) recombination experiments have also investigated the net outcome of changing surface temperature. As discussed above, increasing surface temperature has different effects on the different reaction steps outlined in Equation 14. For a given material, as the temperature increases above room temperature, the O(³P) recombination cross section increases mainly due an increased rate of surface diffusion. However. at higher temperatures the recombination cross section begins to decrease as the rate of desorption exceeds the rate of diffusion. During the temperature cycling that a satellite in VLEO would be exposed to this will likely result in the O(³P) re-emission properties of a material being more specular at lower temperatures and more diffuse at higher temperatures. The presence of N atoms adsorbed on the surface can change O(³P) recombination cross section values, by providing an alternative reaction pathway for O(³P) via the formation of NO and NO₂. However, the presence of adsorbed diatomic molecules generally does not have such an effect.

In many cases when the O(³P) recombination cross section of a non-oxide material is measured, a surface oxide layer is quickly formed during the measurement and so what is in fact measured is the O(³P) recombination cross section of that oxide. Broadly speaking the O(³P) recombination cross section of a material is observed to be dependent upon whether the material is “acidic”, “amphoteric” or “alkaline”. In this context, this refers to whether the material is electron deficient and wants to accept electrons (acidic e.g. As₂O₃), electron rich and wants to donate electrons (alkaline e.g. CaO) or is capable of doing either (amphoteric e.g. ZnO). Generally, “alkaline” materials possess lower O(³P) recombination cross sections than “amphoteric” materials which in turn possess lower values than “acidic” materials.

Silica, and Pyrex in particular, possess the desirable combination of resistance to erosion by atomic oxygen and exceptionally low O(³P) recombination cross section. A previous investigation of the erosion properties of Pyrex has demonstrated its superior O(³P) reflection properties compared to other erosion resistant materials with high recombination cross sections such as Au. The desirable properties of oxides, and silica in particular, have led to significant research effort historically being expended into ways of incorporating them as a protective, reflective coating for materials commonly used in space engineering that suffer extensively from erosion. 2D Materials for Atomic Oxygen Resistance and Reflection

2D materials are typically produced by separating the atomic planes of layered van der Waals solids such that the resulting crystal sheets are very thin in comparison to their lateral dimensions.

Graphite is the archetypal van der Waals solid, which can be thinned to produce graphene sheets via a variety of routes including mechanical or liquid phase exfoliation. However, the number of successfully isolated 2D materials has increased enormously in recent years and now includes insulators, metals and semiconductors. Many 2D materials can be synthesized with atomically flat surfaces and very low defect densities on the basal planes, which promises excellent atomic reflection properties.

The 2D material comprises one or more elements, excluding C, N and S, in an amount of at least 50 at. %; and
wherein respective oxides of the one or more elements of the 2D material have a vapour pressure of at most 10 Pa at a temperature of 323 K (referred to herein as non-volatile oxides).

It should be understood that the amount of at least 50 at. % of the one or more elements represents a stoichiometric amount and hence non-stoichiometric deviations therefrom are within scope. By including these one or more elements having non-volatile oxides in the amount of at least 50 at. %, atomic oxygen erosion of the 2D material is improved.

It should be understood that the 2D material comprises C, N and S in an amount of at most 50 at. % (i.e. the sum of the respective amounts of C, N and S is at most 50 at. %). By limiting C, N and S to an amount of at most 50 at. %, atomic oxygen erosion of the 2D material is attenuated. Particularly, since the reaction products with atomic oxygen of C, N and S are generally gaseous, by limiting the content of these particular elements, having volatile oxides, in the 2D material, atomic oxygen erosion thereof is controlled.

Hence, the 2D material not only has excellent atomic oxygen reflection properties but also has improved atomic oxygen erosion properties, due to selection thereof.

For example, the 2D material may consist of a single element, excluding C, N and S, such as borophene, germanane, silicene, stanine, bismuthine and 2D metals such as single or double atomic layers of platinum, palladium or rhodium. Since respective oxides of the one or more elements of the 2D material have a vapour pressure of at most 10 Pa at a temperature of 323 K, plumbene, phosphorene and antimonene are thus excluded. Since the 2D material comprises C, N and S in an amount of at most 50 at. %, graphene is thus excluded. For example, the 2D material may comprise or consist of two elements including one of C, N and S, such as hBN. For example, the 2D material may comprise or consist of more than two elements including one or more of C, N and S. For example, the 2D material may comprise or consist of two or more elements not including any of C, N and S, such as MoSe₂, MoTe₂, WS₂, NbSe₂ and MXenes (Mₙ₊₁XₙTₓ; n is in the range 1 to 4; M represents an early transition metal; X represents C and/or N; and Tₓ represents a surface termination). Since the 2D material comprises C, N and S in an amount of at most 50 at. %, MoS₂ and some borocarbonitrides are thus excluded.

In one example, the 2D material comprises the one or more elements, excluding C, N and S, in an amount of at least 66 at. %, preferably at least 75 at. %.

In one example, the coating comprises, substantially comprises (i.e. at least 50 wt. % by weight of the coating), essentially comprises (i.e. at least 99 wt. % by weight of the coating) or consists (excluding unavoidable impurities) of one or more of such 2D materials.

It should be understood that respective oxides of the one or more elements of the 2D material must be heated to a temperature greater than 323 K to obtain a vapour pressure of at least 10 Pa. It should be understood that these oxides are the binary oxides, consisting of oxygen and the respective elements, being the thermodynamically stable oxides thereof. It should be understood that one or more oxides of the respective elements may be formed, including thermodynamically metastable oxides, and/or ternary, quaternary and/or higher-order oxides. It should be understood that the 2D material has a vapour pressure of at most 10 Pa at a temperature of 323 K. Generally, respective thermodynamically stable oxides of C, N and S have a vapour pressure of at least 10 Pa at a temperature of 323 K. It should be understood that stability in the context of the oxides refers to the temperature and pressure conditions in use e.g. at LEO or VLEO.

In one example, the coating comprising a plurality of such 2D materials, for example a mixture thereof.

In one example, the respective oxides of the elements are of the relatively more or most stable respective oxides of the elements.

By way of example, consider oxides of selenium SeO₂ and SeO₃, having relatively low melting points of 340° C. and 118° C., respectively, while SeO₃ starts to sublime above 100° C. SeO₂ is relatively more stable than SeO₃. Hence, selenium and oxides thereof may usefully define a threshold. In one example, respective oxides of the elements of the 2D material have a vapour pressure lower than the vapour pressure of SeO₃ at 362 K.

The vapour pressure of SeO₃ at 362 K (89° C.) is 20.6 Pa.

Since vapour pressure always increases with temperature, the vapour pressure may be defined in terms of temperature e.g. what is the temperature at which the vapour pressure is 10 Pa? If this temperature is relatively higher, the oxide is relatively less volatile.

The vapour pressure of SeO₂ is 10 Pa at about 144° C.

The vapour pressure of SeO₃ is 10 Pa at about 63° C. (about the same as Hg for reference).

In contrast, oxides of Mo and W are much less volatile than the oxides of Se, having melting points greater than 795° C. for all MoO₂, MoO₃, WO₂ and WO₃.

Te, like Se, is a chalcogen. The vapour pressure of TeO₂ is 10 Pa at about 710° C.

Respective oxides of Mo, W, Se, Al, As, Cd, Pb, Sr, Sb, P, Rh have a vapour pressure of at most 10 Pa at a temperature of 323 K. In one example, the elements are selected, at least in part, from Mo, W, Se, Te, Al, As, Cd, Pb, Sr, Sb, P and Rh.

Generally, transition metal oxides have a vapour pressure of at most 10 Pa at a temperature of 323 K. In one example, the elements are selected from the transition metals, for example from Periods 4 to 7 and Groups 3 to 12, preferably Periods 4 to 6 and Groups 3 to 12. In one example, the elements are selected, at least in part, from:
Period 4: Sc, Ti, V, Cr, Mn, Fe, Co, Ni, Cu, Zn
Period 5: Y, Zr, Nb, Mo, Tc, Ru, Rh, Pd, Ag, Cd
Period 6: La, Hf, Ta, W, Re, Os, Ir, Pt, Au, Hg
Period 7: Ac, Rf, db, Sg, Bh, Hs, Mt, Ds, Rg, Cn

In one example, the elements are selected, at least in part, from Se, Te, Al, As, Pb, Sr, Sb, P and Rh and the transition metals.

Transition Metal Dichalcogenides

In one example, the 2D material is a transition metal dichalcogenide, TMD, having a chemical formula MX₂, wherein M is a transition metal, preferably a second row or a third row transition metal (i.e. Period 4 or Period 5), and X is a chalcogen (i.e. Group 16, oxygen and sulphur excluded).

After graphene and hBN, the other most commonly studied 2D materials are the transition metal dichalcogenides (TMDs), including MoS₂, MoSe₂, MoTe₂, WS₂, NbSe₂ etc.

Previously, it has been found that MoS₂ displayed apparently inferior reflection properties to both graphene and hBN, due to the atomic level corrugations at its surface. Nonetheless, the material still displayed superior properties than would be expected for purely diffuse reflection so its reflection and erosion properties are worthy of further consideration. Due to its use as a solid lubricant for spacecraft, a number of studies into the effect of O(³P) exposure upon MoS₂ have been performed. The studies have shown that, like graphene and hBN, MoS₂ undergoes erosion when exposed to O(³P) via the formation of volatile oxides. In this case, SO is the volatile oxide and what is left behind initially is a MoSₓO_{y} phase that converts to MoO₃ upon prolonged exposure. The same studies have also shown that this oxidation process is limited to the top few nanometers of the MoS₂ surface as the formed MoO₃ layered oxide is passivating to further oxidation. Limited studies into other isostructural transition metal dichalcogenides like WS₂ have also been performed and displayed similar results. Like with hBN, to date no studies into the O(³P) reflection properties of transition metal dichalcogenides have been performed.

The structure of TMDs is like a ‘sandwich’, the single molecular layer contains three atomic layers in which two layers of chalcogen atoms sandwich the layer of transition metal atoms. The force type between each mono-layer is van der Waals.

In order to realize the full potential of these materials for scientific technologies, various fabrication methods are being studied, for instance, chemical vapor deposition is used for producing large-scale 2D materials while exfoliation techniques are developed for 2D materials dispersion. In this study, 2D material coatings are being developed for use in space applications, which require high quality coatings.

In one example, X is Se or Te.

In one example, the TMD is: ScSe₂, TiSe₂, VSe₂, CrSe₂, MnSe₂, FeSe₂, CoSe₂, NiSe₂, CuSe₂, ZnSe₂, YSe₂, ZrSe₂, NbSe₂, MoSe₂, TcSe₂, RuSe₂, RhSe₂, PdSe₂, AgSe₂, CdSe₂, LaSe₂, HfSe₂, TaSe₂, WSe₂, ReSe₂, OsSe₂, IrSe₂, PtSe₂, AuSe₂, HgSe₂, ScTe₂, TiTe₂, VTe₂, CrTe₂, MnTe₂, FeTe₂, CoTe₂, NiTe₂, CuTe₂, ZnTe₂, YTe₂, ZrTe₂, NbTe₂, MoTe₂, TcTe₂, RuTe₂, RhTe₂, PdTe₂, AgTe₂, CdTe₂, LaTe₂, HfTe₂, TaTe₂, WTe₂, ReTe₂, OsTe₂, IrTe₂, PtTe₂, AuTe₂ or HgTe₂.

Whilst it is clear that the reflection properties of hBN and MoS₂ make them worthy targets for potential VLEO coatings they both suffer problems of erosion and surface roughening due to the formation of volatile oxidation products when exposed to O(³P). Nonetheless, there are many other two dimensional materials yet to be investigated for this application. Within these may be 2D materials that form only non-volatile oxidation products and therefore could potentially exhibit less surface erosion and roughening when exposed to O(³P). An example could be the transition metal diselenides or ditellurides, where although isostructural to MoS₂ these heavier chalcogens would likely result in the formation of less volatile oxide species. Alternatively, black phosphorous is known to form a stable and protective POₓ surface layer which may provide self-passivation. Many of the self-passivating layers and layered oxides are insulating, but by combining two or more 2D materials it may be possible to achieve sufficient doping of the oxide to prevent charging problems in orbit. We also note that the parameter space for optimizing synthesis of 2D material coatings and nanocomposites is large, for example the layered phase can be incorporated into nanocomposites simply as nanoparticulate fillers or via incorporation of suitable precursors in the polymer melt, or they can be sprayed, painted or printed onto the surface. Although research into the O(³P) reflection and erosion behaviour of more exotic 2D and layered van der Waals solids is limited, it is clear that within this class of materials may be the ideal combination of good atomic oxygen erosion resistance and reflection properties necessary to achieve sustained satellite operation in VLEO.

In one example, M is a group 5 transition metal, such as Nb or Ta, or a group 6 transition metal, such as Mo or W.

In one example, the TMD is NbSe₂, TaSe₂, MoSe₂, WSe₂, NbTe₂, TaTe₂, MoTe₂, WTe₂, preferably MoSe₂ or WSe₂.

In one example, the TMD is MoSe₂, WSe₂ or NbSe₂, preferably MoSe₂ or WSe₂.

In one example, the 2D material comprises flakes thereof, having a dimension, transverse to a thickness thereof (for example one or a few atomic layers), in a range from 5 nm to 390 nm, preferably in a range from 10 nm to 200 nm, more preferably in a range from 15 nm to 100 nm. While pristine monolayer sheets are generally preferred, production of pristine monolayer sheets having areas suitable for coating a spacecraft is not currently feasible. Hence, flakes are suitable, having thicknesses in the described ranges.

In one example, the coating has a roughness average Rₐ in a range from 0 nm to 50 nm, preferably in a range from 10 nm to 40 nm, more preferably in a range from 15 nm to 35 nm. By reducing the roughness average Rₐ, drag is reduced. The roughness average Rₐ may be measured over a distance of 1 μm and hence is of a plurality of flakes.

2D Material, Coating or Coating on a Substrate

The second aspect provides a 2D material, a coating comprising a 2D material or a coating comprising a 2D material on a substrate, wherein the 2D material is according to the first aspect.

Method of Protecting

The third aspect provides a method of protecting, at least in part, a spacecraft, for example a satellite such as a Very Low Earth Orbit, VLEO, satellite, or any part thereof according to the first aspect, the method comprising:
exposing the coating to atomic oxygen incident thereupon, reacting the one or more elements of the 2D material with the atomic oxygen and producing respective oxides of the one or more elements.

In this way, the coating is resistant to erosion by the atomic oxygen since the products of the reaction of the elements with the atomic oxygen (i.e. the respective oxides of the elements of the 2D material) are not vaporised, having a vapour pressure of at most 10 Pa at a temperature of 323 K. In other words, the oxides are solid, like the 2D material. Since these oxides are solid, they are retained as part of the coating (c.f. gaseous oxides), the integrity of which is better maintained.

Method of Providing Coating

The fourth aspect provides a method of providing a coating on a substrate for a spacecraft, for example a satellite, the method comprising:
providing a 2D material by liquid phase exfoliation, LPE, for example sonication-assisted LPE; and
depositing the 2D material on the substrate by electrophoretic deposition, EPD, thereby providing the coating on the substrate;
optionally wherein the 2D material is a transition metal dichalcogenide, TMD, having a chemical formula MX₂, wherein M is a transition metal, preferably a second row or a third row transition metal, and X is a chalcogen.

The 2D material may be described with respect to the first aspect.

Exfoliation

Due to the fact that the particle size of a 2D material will influence the quality of coatings obtained from it, methods to try and control particle size and concentration in dispersion developed rapidly.

Different exfoliation methods have been developed for producing 2D nanomaterial with a high aspect ratio and large surface area, for example, thermal exfoliation, mechanical exfoliation, and ultrasonic exfoliation.

Thermal Exfoliation

A MoO₃ dispersion may be produced by thermal exfoliation. Briefly, MoO₃ is added into ethanol, ground with a mortar after the reaction (intercalation method), put in a ceramic dish. Putting evaporating dish that contain samples in a preheated furnace for thermal exfoliation, collect the powder after the dish cooling down in air. This method is widely used in exfoliation of 2D materials but it is limited by the fact that it requires a very high temperature. In addition, as the main purpose of this study is to prepare pristine samples for testing in the space environment, the fact that thermal exfoliation cannot avoid large area oxidation which would change the film properties is undesirable.

Mechanical Exfoliation

Mechanical exfoliation is regarded as the original and the simplest method to synthesize graphene. To the methods produce graphene by applying normal force to the surface of Highly Ordered Pyrolytic Graphite (HOPG) by scotch tape. After repeating several times, the graphite finally becomes single layer. This technique can make monocrystalline 2D material films and the process is simple, by applying normal force repeatedly to exfoliate. Although the process seems simple, but it depends on the manual operation costs time and cannot produce scalable products

Electrochemical Exfoliation

This equipment includes: working electrode, counter electrode, reference electrode, electrolyte, and power supply. The working electrode and counter electrode are dipped into electrolyte, the voltage is applied on the working electrode to exfoliate the material. For the process of preparing graphene by electrochemical exfoliation, graphite used as working electrode, Pt used as counter electrode, applied voltage drives the electrolyte ionic intercalate into the spaces of graphite layer and increase the interlayer and cause the exfoliation.

Sonication-Assisted Liquid Phase Exfoliation (LPE)

Sonication-assisted liquid phase exfoliation is scalable and easily controlled. A wide variety of 2D materials have been successfully exfoliated by LPE. FIG. 7 shows the simple process of LPE. The dispersion prepared by this method compare to mechanical exfoliation can easily deposit dispersion in the variety of substrates.

Generally, LPE includes three steps:
a. dispersion of the 2D material precursor in a solvent;
b. exfoliation of the dispersion into 2D flakes;
c. purification.

The frequency and power of the ultrasonic bath, as well as the selection of the solvent allow for control of the quality of the 2D material dispersion in terms of concentration and particle size distribution. After exfoliation, centrifugation is used to separate the 2D material dispersion from larger particles, with the relative centrifugal force (RCF) of the centrifugation also affecting the concentration and particle size distribution of the 2D material dispersion. It is known that the solvent, exfoliation conditions and centrifugation process should be optimised for different precursor materials. LPE has been applied in many recent 2D material studies as a rapid and effective exfoliation technique.

In one example, providing the 2D material by LPE comprises dispersing a 2D material precursor in a liquid phase, exfoliating the 2D material precursor dispersed in the liquid phase, for example by sonication, and purifying the exfoliated 2D material, for example by centrifugation, thereby providing the 2D material.

Generally, the liquid phase is selected according to the 2D material precursor and/or 2D material. For example, for TMDs, the liquid phases typically IPA.

In one example, exfoliating the 2D material precursor dispersed in the liquid phase by sonication comprises sonicating the 2D material precursor dispersed in the liquid phase at a power in a range from 25 W to 1 kW, preferably in a range from 50 W to 500 W, more preferably in a range from 75 W to 150 W, for example 100 W, 110 W or 120 W for 1 g of the 2D material precursor dispersed in 100 ml of the liquid phase, optionally at a frequency in a range from 20 kHz to 1174 kHz, preferably in a range from 25 kHz to 100 kHz, more preferably in a range from 30 kHz to 50 kHz, for example 35 kHz, 37 kHz or 40 kHz, optionally for a duration in a range from 0.5 hours to 12 hours, preferably in a range from 2 hours to 6 hours, for example 4 hours, optionally at a temperature in a range from 283 K to 313 K, preferably in a range from 288 K to 303 K.

In one example, the 2D material comprises flakes thereof, having a dimension, transverse to a thickness thereof, in a range from 5 nm to 390 nm, preferably in a range from 10 nm to 200 nm, more preferably in a range from 15 nm to 100 nm.

Deposition

Chemical Vapor Deposition (CVD)

Due to its low cost and the feasibility of large-scale production, CVD is the most well-known and promising approach in producing large area sheets of graphene and beyond graphene materials. The principle is forming volatile substances, transferring to the deposition area and producing chemical reaction. The operation step is generally to introduce a reaction gas into a single-temperature zone tube furnace under vacuum or an inert atmosphere, raise the temperature of the furnace to the decomposition temperature of the compound, and decompose it to deposit the target product on the substrate.

However, CVD needs high temperature, requires precursors that are in the form of gases. In addition, the method requires vacuum-assistance and the temperatures as high as 1000° C. consume large quantities of energy. Additionally, sometimes the coatings exhibit wrinkles due to thermal expansion. Due to the high temperature is inconvenient in the lab, it may increase the cost of experiment significantly.

Electrophoretic Deposition (EPD)

Electrophoretic deposition is widely used to deposit fine powders (typically <30 μm particle diameter) or colloidal suspensions onto electrode surfaces. The application of a DC electric field between two electrodes causes the suspended particles to move towards the cathode or anode by electrophoresis due to the surface charge borne by the particles. Once at the electrode, deposition and coating can occur by a number of proposed mechanisms including:
(1) Particle charge neutralization: upon contacting the electrode, particles lose their charge and deposit.
(2) Electrochemical coagulation: the repulsion between particles decreases, and the concentration of electrolyte around the particles increases, causing the particles to deposit.

The basic equation to describe the kinetics of electrophoretic deposition is shown below:

$$\frac{d Y}{d t} = f μ E S c$$

where Y is the deposition yield (kg); t is the deposition time (s); μ is the electrophoretic mobility (m²·V⁻¹·s⁻¹); p is the surface area of the electrode (m²); c is the solids concentration (kg·m⁻³); f is the fraction of particles taking part in the deposition, f≤1.

There are many advantages for EPD: for example, EPD may provide coatings having a uniform thickness and/or hardness, while adhesion impact properties of the electrophoretic film may be significantly better than for other coating processes.

In one example, depositing the 2D material on the substrate by EPD comprises preparing a suspension of the 2D material, immersing the substrate in the suspension and applying a voltage in a range between 5 V and 30 V, preferably between 10 V and 20 V between the immersed substrate and a counter electrode. Typically, the suspension of the 2D material is prepared using the same liquid phase as for the exfoliation.

In one example, applying the voltage comprises applying the voltage for a duration in a range from 0.5 hours to 6 hours, preferably in a range from 1 hour to 3 hours.

Use

A fifth aspect provides use of a 2D transition metal dichalcogenide, TMD, preferably MoSe₂ or WSe₂, as an atomic oxygen erosion-resistant coating on a Very Low Earth Orbit, VLEO, satellite.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts the upper and lower altitudes (dashed black times) that define VLEO. How atmospheric density varies with altitude at high (purple line) and low (gold line) solar flux is also displayed. Finally, the percentage contributions of the four major components of the LEO atmosphere, He (green), 0 (pale blue), N₂ (dark blue) and O₂ (red) to the overall atmospheric density, as a function of altitude are displayed in the graph background. Data used to generate this figure are representative and were obtained from the NRLMSISE model.

FIG. 2 schematically depicts elastic specular (left) and thermal diffuse (right) reemission patterns for a nominal one-sided flat plate geometry, wherein vᵢ and vᵣ are the incident and re-emitted particle velocities, θᵢ and θᵣ the corresponding incidence angles with respect to the surface normal n, and D and L are representative drag and lift forces.

FIG. 3 schematically depicts drag and lift coefficients as a function of incidence angle θ derived from the Schaaf and Chambre GSI model for a one-sided flat panel. Fully diffuse and complete specular reflection cases presented.

FIG. 4 schematically depicts the interaction potential ε/eV (blue curve) experienced by an O(³P) (red sphere) as a function of the distance r/Å from the surface of a satellite (grey cuboid).The attractive regime is defined as the range of distances for which the interaction potential is <0; the repulsive regime is defined as the range of distances for which the interaction potential is >0.

FIG. 5 schematically depicts drag (top curve) and lift (bottom curve) coefficients as a function of incidence gas particle mass derived from Sentman's equations for a one-sided flat panel at three different incidence angles θ.

FIG. 6 schematically represents monoatomic reaction steps (left) and diatomic reaction steps (right). A: Chemisorption; B: Physisorption; C: Desorption; D: Surface diffusion; E: Surface diffusion to an active site; F: Langmuir-Hinshelwood recombination; and G: Eley-Rideal recombination. O(3P) atoms are represented by blue spheres, the surface by the grey cuboid and defect sites on the surface by the pair of X.

FIG. 7 schematically depicts a process of LPE.

FIG. 8 schematically depicts a process of EPD.

FIG. 9 shows particle size distributions, obtained by DLS, for 2D materials according to exemplary embodiments.

FIG. 10 shows particle size distributions, obtained by DLS, for 2D materials according to exemplary embodiments.

FIG. 11 shows particle size distributions, obtained by DLS, for 2D materials according to exemplary embodiments.

FIG. 12 shows particle size distributions, obtained by DLS, for 2D materials according to exemplary embodiments.

FIG. 13 shows Raman shift for 10V 1 h deposition, for 2D materials according to exemplary embodiments.

FIG. 14 shows Raman microscope images for 10V 1 h deposition, for 2D materials according to exemplary embodiments.

FIGS. 15A to 15D show AFM images for 10V 1 h deposition, for 2D materials according to exemplary embodiments.

FIGS. 16A to 16D show SEM EDS data for 10V 1 h deposition, for 2D materials according to exemplary embodiments.

FIG. 17 show EDS spectra for 10V 1 h deposition, for 2D materials according to exemplary embodiments.

FIGS. 18A to 18B show Raman shift and Raman microscope images for 10V 2 h deposition, for 2D materials according to exemplary embodiments.

FIGS. 19A to 19D show AFM images for 10V 2 h deposition, for 2D materials according to exemplary embodiments.

FIGS. 20A to 20B show SEM EDS data for 10V 2 h deposition, for 2D materials according to exemplary embodiments.

FIGS. 21A to 21B show Raman shift and Raman microscope images for 10V 3 h deposition, for 2D materials according to exemplary embodiments.

FIGS. 22A to 22D show AFM images for 10V 3 h deposition, for 2D materials according to exemplary embodiments.

FIGS. 23A to 23B show SEM EDS data for 10V 3 h deposition, for 2D materials according to exemplary embodiments.

FIGS. 24A to 24B show Raman shift and Raman microscope images for 15V 1 h deposition, for 2D materials according to exemplary embodiments.

FIGS. 25A to 25D show AFM images for 15V 1 h deposition, for 2D materials according to exemplary embodiments.

FIGS. 26A to 26B show Raman shift and Raman microscope images for 20V 1 h deposition, for 2D materials according to exemplary embodiments.

FIGS. 27A to 27D show AFM images for 20V 1 h deposition, for 2D materials according to exemplary embodiments.

FIGS. 28A to 28B show Raman shift and Raman microscope images for 10V 1 h deposition after baking, for 2D materials according to exemplary embodiments.

FIGS. 29A to 29D show AFM images for 10V 1 h deposition after baking, for 2D materials according to exemplary embodiments.

FIGS. 30A to 30E show SEM EDS data for 10V 1 h deposition after baking, for 2D materials according to exemplary embodiments.

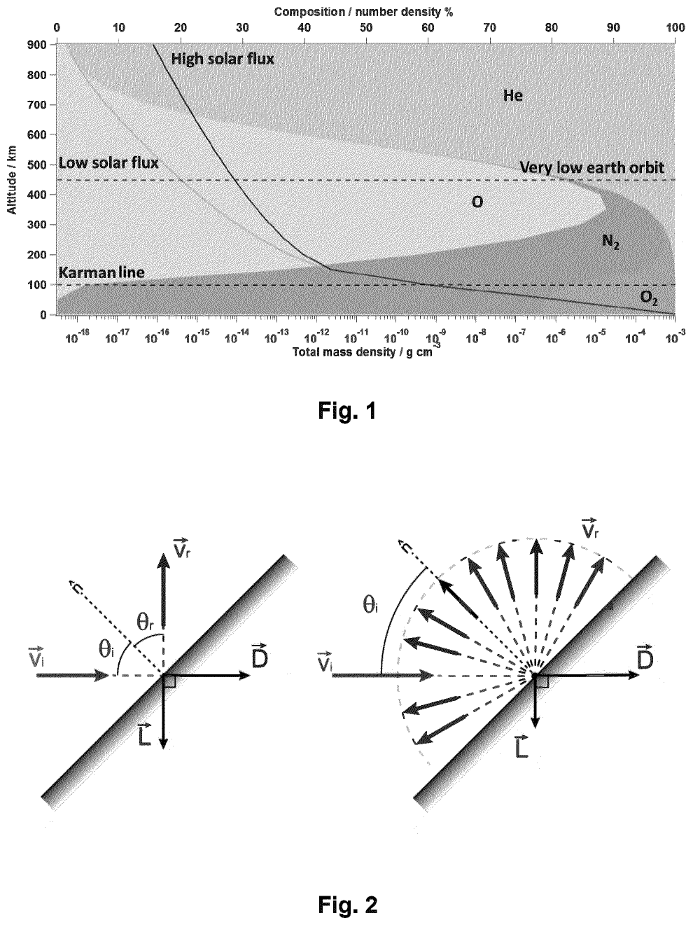

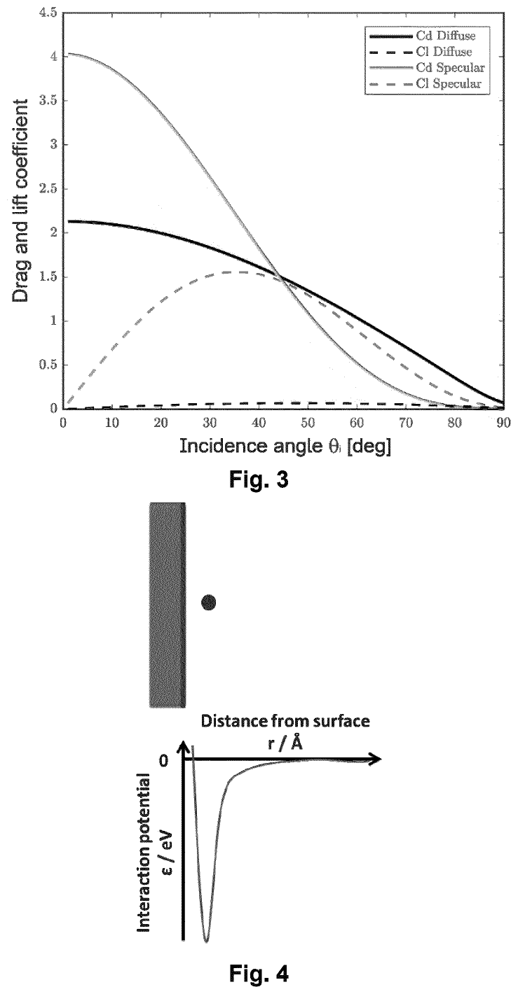

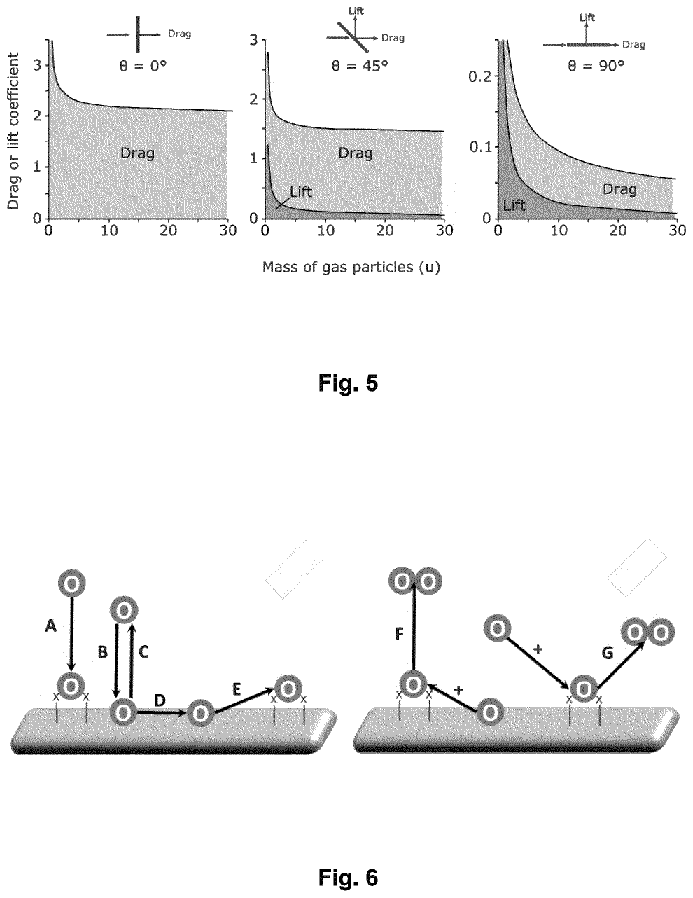

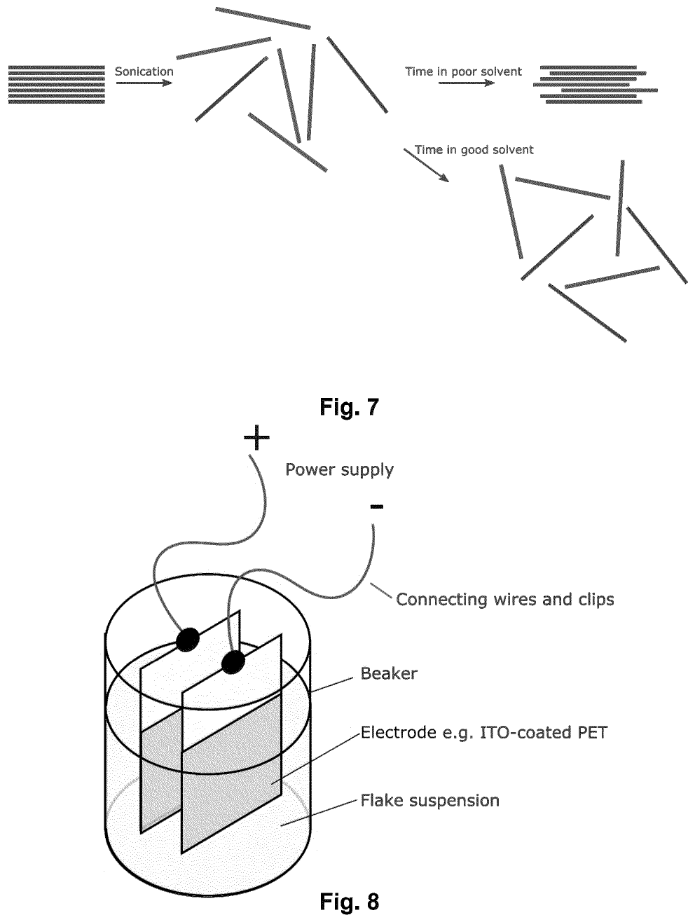

### DETAILED DESCRIPTION OF THE DRAWINGS

Materials and Chemicals

All the materials and chemicals in this experiment were commercially provided and used without further purification: Boron Nitride, 99.5% (metals basis) −325 mesh powder (Alfa Aesar). Molybdenum (IV) selenide, 99.9% trace metals basis, −325 mesh (Aldrich). Tungsten (IV) selenide, 99.8% metals basis, 10-20 μm powder (Alfa Aesar). Niobium selenide, 99.8% metal basis, 5 μm powder (Alfa Aesar). IPA, 2-propanol, ≥99.5% (GC), (Sigma-Aldrich). Indium tin oxide coated PET, surface resistivity 600/sq.

Exfoliation

In this study, there are four materials to be exfoliated.

In general, 1 g molybdenum diselenide, tungsten diselenide, niobium diselenide or Hexagonal Boron Nitride was weighed then added into 100 ml IPA. Suspensions were put in the sonication bath set at 50% power output (100% power output is 220 W effective ultrasonic power, 880 W peak ultrasonic power) and 37 kHz to sonicate for 4 hours, after which a pipette was used to transfer the supernatant into centrifugation tubes, which was then centrifuged twice at 4500 rpm for 30 min. After each centrifugation cycle, the supernatant was separated from sedimented material and added to fresh centrifugation tubes for the next centrifugation cycle or for electrophoretic deposition. During all sonications, water bath temperature was controlled by flowing 5° C. water through a cooling coil submerged in the bath. Typical measured bath temperatures during sonication were 23-51° C. Other sonication conditions attempted, including increasing sonicator power output to 70%, decreasing precursor concentration to 0.5 g per 100 ml and allowing the sonication bath to run uncooled. Although these modified conditions did produce exfoliated flake suspensions, these suspensions were less suitable for electrophoretic deposition and were not carried forward.

Deposition

Both applied voltage and deposition time influence electrophoretic deposition. Therefore, several different combinations of applied voltage and deposition time were attempted, namely: 10V 1 h, 10V2 h, 10V3 h, 15V1 h, 20V1 h.

For electrophoretic deposition, two pieces of ITO-coated PET films of approximate dimensions 5 cm by 8 cm were used as the anode and cathode. These two sheets were placed parallel in a beaker with the ITO surfaces face to face, separated by approximately 1 cm. To the top of each sheet was attached a clip to allow electrical connection to a power supply. The 2D material suspension was then added into the beaker, with the submerged area of each sheet being approximately 5 cm by 7 cm.

Characterization

DLS measurements were conducted using a Zetasizer Nano-S(Malvern Instrument, UK) operated according to manufacturer's instructions.

SEM EDS was performed using a tandem FEI Quanta 250 (Environmental) Scanning Electron Microscope. AFM was performed using a Multimode 8 Atomic Force Microscope (Bruker, USA) with PeakForce QNM mode with ScanAssyst activated. MPP-21100-10 Sb (n) doped Si cantilevers were used. Confocal Raman spectroscopy was used to test 10 accumulations per 10 s. Instruments were operated according to manufacturers' instructions.

Results & Discussion

Results of Dispersion

Dynamic light scattering (DLS) was used to characterise the particle size of the exfoliated flake dispersions, reported below as hydrodynamic diameter.

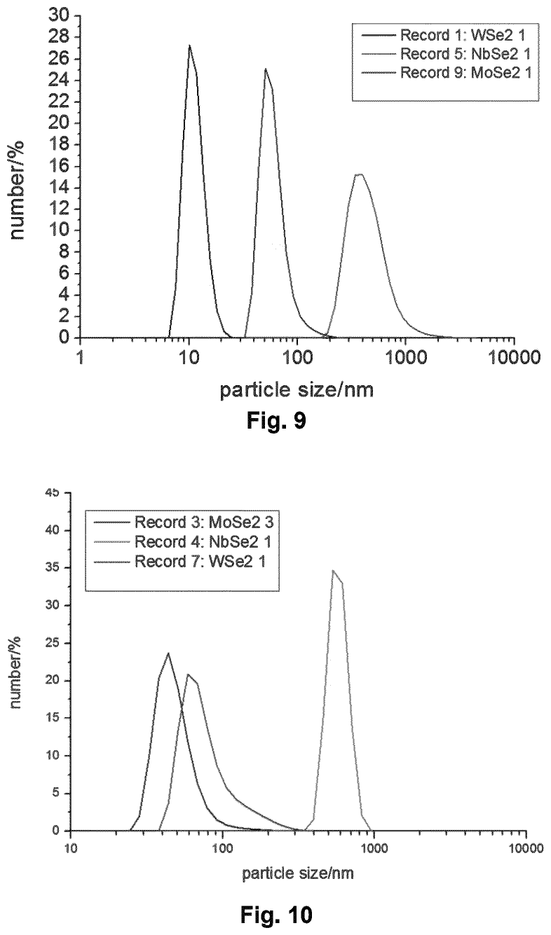

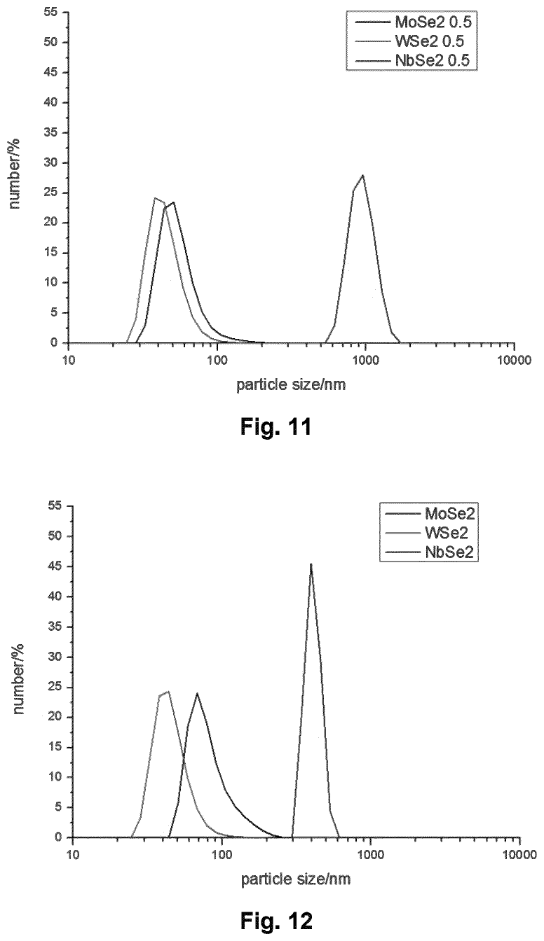

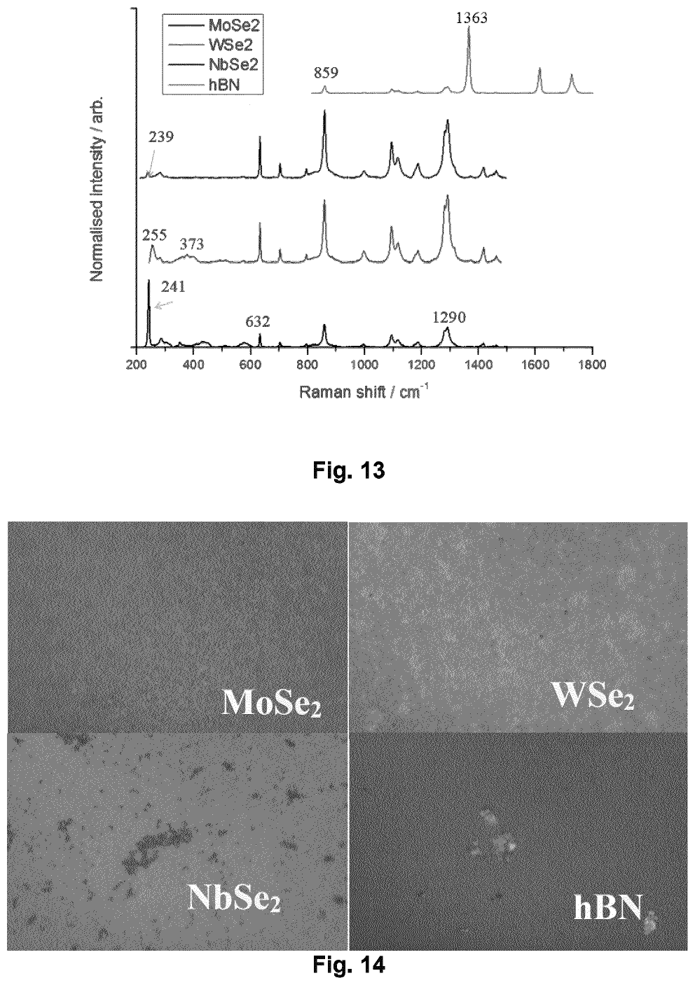

As we can see in FIG. 9 the particle size of WSe₂ and MoSe₂ are on average 10 nm and 60 nm respectively, whilst NbSe₂ exhibits a larger particle size at about 400 nm. The particle size of hBN is not given here since because the particle size of hBN was too large for DLS to measure reliably.

Electrophoretic Deposition Results

Electrophoretic deposition was conducted by applying a fixed voltage between the ITO-coated PET sheets for the required deposition time, After electrophoresis, the ITO-coated PET electrode onto which deposition had occurred was removed from the suspension, had drops of residual solvent blown away with a stream of nitrogen gas and allowed to dry in ambient air, After the process of deposition, Raman, AFM and SEM-EDS were used to ensure the presence of the materials on the ITO coated PET and to assess the quality of the coatings.

Several deposition times and voltages were applied to optimise the coating.

Deposition Conditions: 10 V 1 h

For the deposition at 10V for 1 h, Raman spectroscopy reveals the following peaks: By comparison to the Raman spectra of MoSe₂ from literature [66], the peak between 238 and 246 cm⁻¹ is the range of MoSe₂, and the peak of 241 cm⁻¹ represents the MoSe₂. The WSe₂ shows a peak at 255 cm⁻¹ and there is a wide peak at 373 cm⁻¹. According to the literature, the wide peak is probably due to Raman insensitivity for WSe₂ or the bond of W—O, which suggests WSe₂ has been partially oxidised.

In the Raman spectra of hBN, there is a significant peak at 1363 cm⁻¹, which is the evidence of the existence of hBN flakes with the significant intensity suggesting the concentration on the surface is high.

For NbSe₂, a minor peak is observed at 239 cm⁻¹, consistent with the E_{g}¹ mode. Low intensity of peaks from NbSe₂ suggests the concentration is low. The other peaks not mentioned are characteristic peaks of PET.

Under conditions of 10V and 1 h, Raman shift shows confirms the existence of the deposited 2D materials.

FIG. 14 shows that that MoSe₂ and WSe₂ are evenly dispersed across the surface but NbSe₂ and hBN contain large particles and the sample looks patchy.

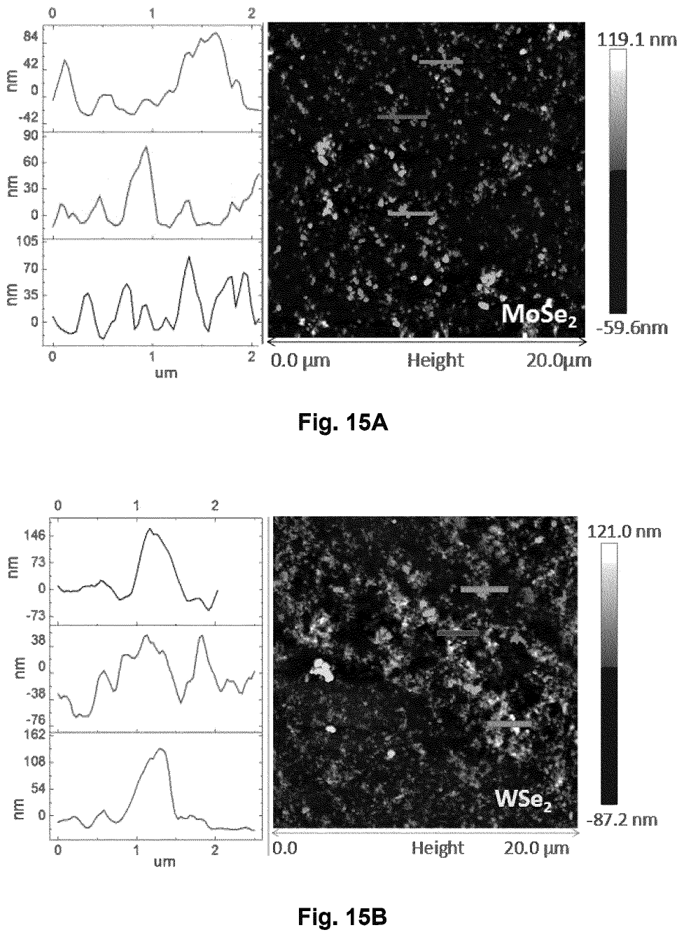

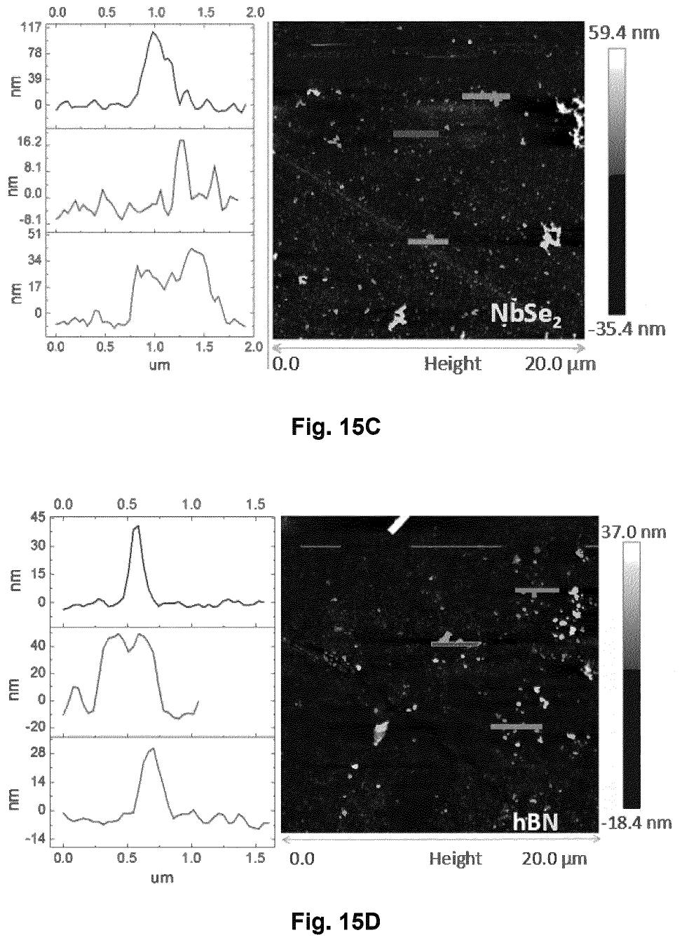

FIGS. 15A to 15D show AFM images for 10V 1 h deposition.

TABLE 1
Sample roughness.

| Material | Roughness Rₐ (nm) |
|---|---|
| MoSe₂ | 15.4 |
| WSe₂ | 20.2 |

To estimate the step height of deposited flakes, line scans were extracted at three points in each image showing typical step heights.

The Rₐ roughness of MoSe₂ and WSe₂ are 15.4 nm and 20.2 nm respectively. However, overall image Rₐ roughness will be not be representative of the surface roughness experienced by impinging gas molecules, since coatings of deposited flakes will consist of flat plateaus on a flat background, with flake edge step height changes contributing to an apparently high Rₐ roughness value (i.e. Rₐ is expected to be high for a patchy deposition, such as where the flakes are not deposited uniformly, including regions having a single flake thickness deposited thereupon, some regions having no flakes deposited thereupon and some other regions including stacks of deposited flakes). That is, the impinged surfaces are atomically flat, even if the flakes are not uniformly deposited.

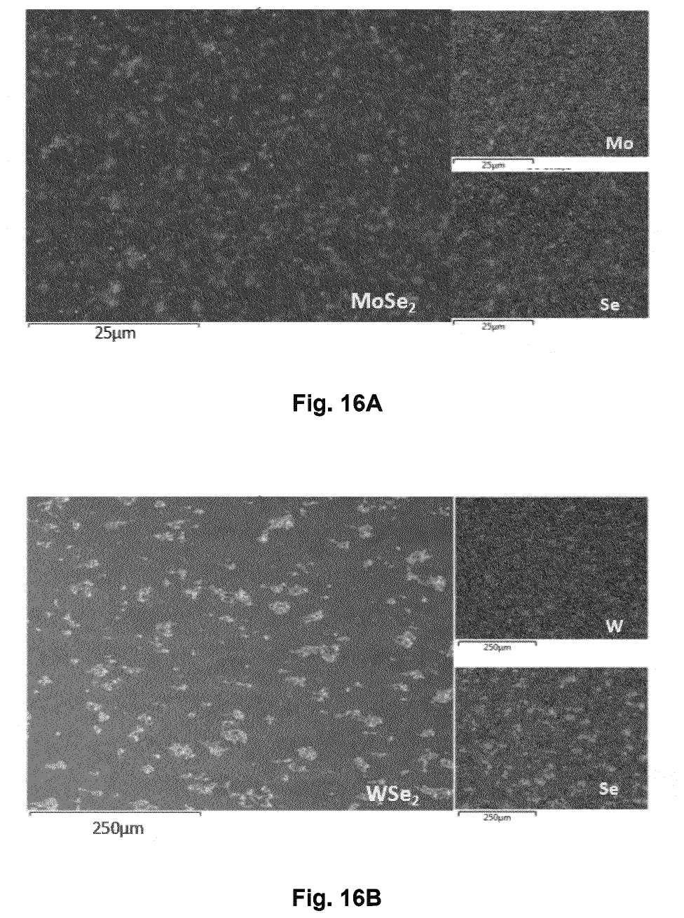

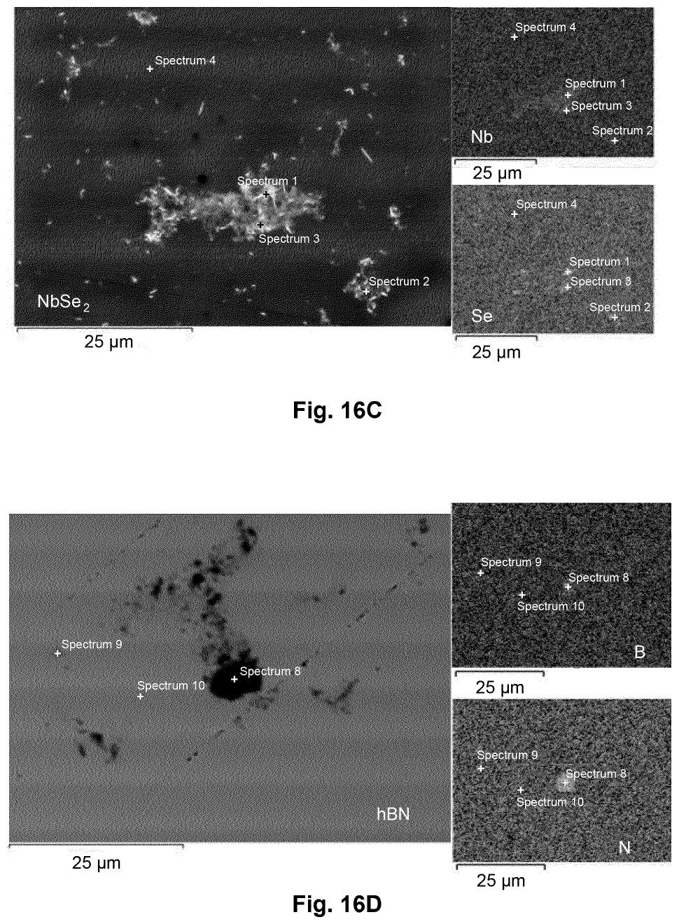

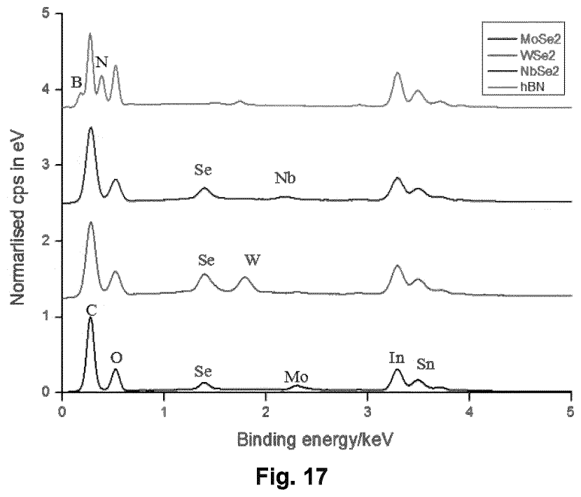

SEM EDS helps us analyze the surface of material and the elemental composition. From FIGS. 16A to 16D we can see the morphology and surface elemental maps of four materials. If can be seen that hBN and NbSe₂ are patchy whereas MoSe₂ and WSe₂ are deposited evenly.

TABLE 2
Elemental composition ratio.

| MoSe₂ | WSe₂ | NbSe₂ | hBN |
|---|---|---|---|
| Mo: 0.5 | W: 1.6 | Nb: 0.1 | B: 2.4 |
| Se: 0.9 | Se: 1.2 | Se: 0.2 | N: 2.1 |

From Table 2 and FIGS. 16A to 16D, for MoSe₂, NbSe₂ and hBN, the elemental ratios are around the expected 1:2 or 1:1. For WSe₂, the elemental ratio is not 1:2. The assumption is the materials experience oxidation, as the W—O peak broadens at 300-400 cm⁻¹.

Deposition Conditions: 10V 2 h

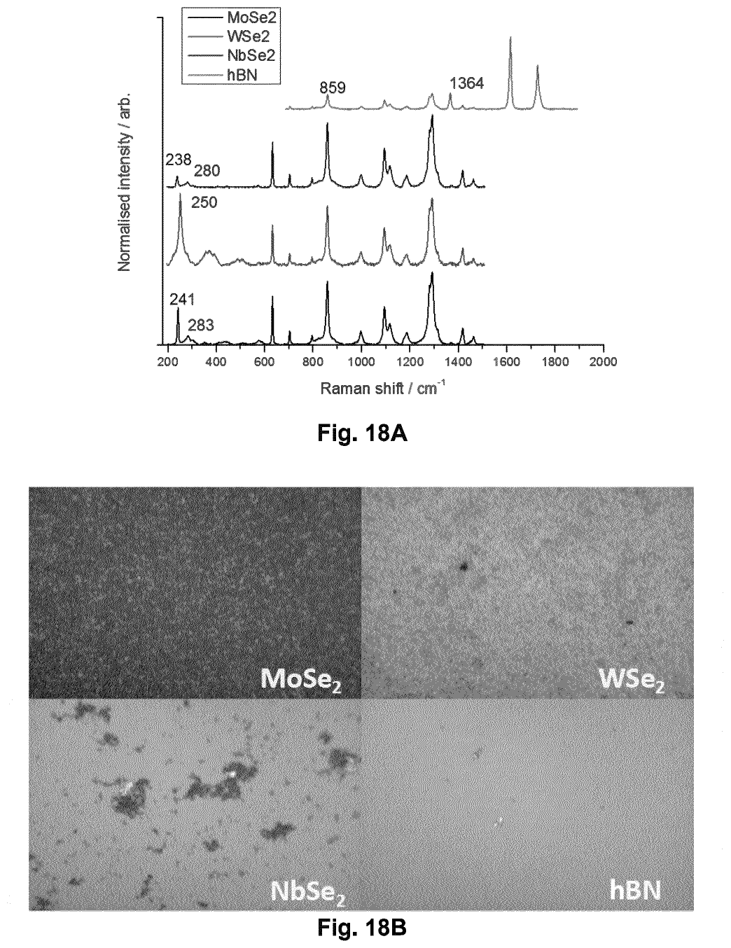

FIGS. 18A and 18B show Raman shift and Raman microscope images for 10V 2 h deposition, for 2D materials according to exemplary embodiments. WSe₂ and MoSe₂ show a good deposition, the peak of WSe₂ is at 250 cm⁻¹ and MoSe₂ is at 241 cm⁻¹. There are wide peaks around 280 cm⁻¹ which still need to be identified. There is a small signal of NbSe₂ at 238 cm⁻¹ and the intensity is weak. It can be seen that at 1364 cm⁻¹ is the peak of hBN. FIG. 18B shows the uniformity of coating. From the image of NbSe₂ is clear that the material is patchy and that hBN deposits poorly, possibly in large chunks.

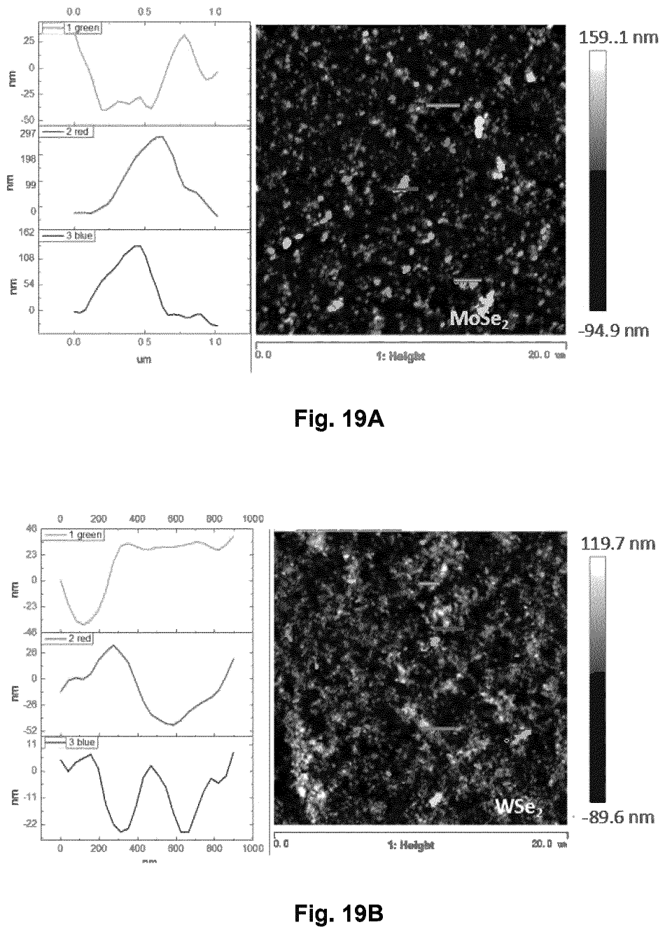

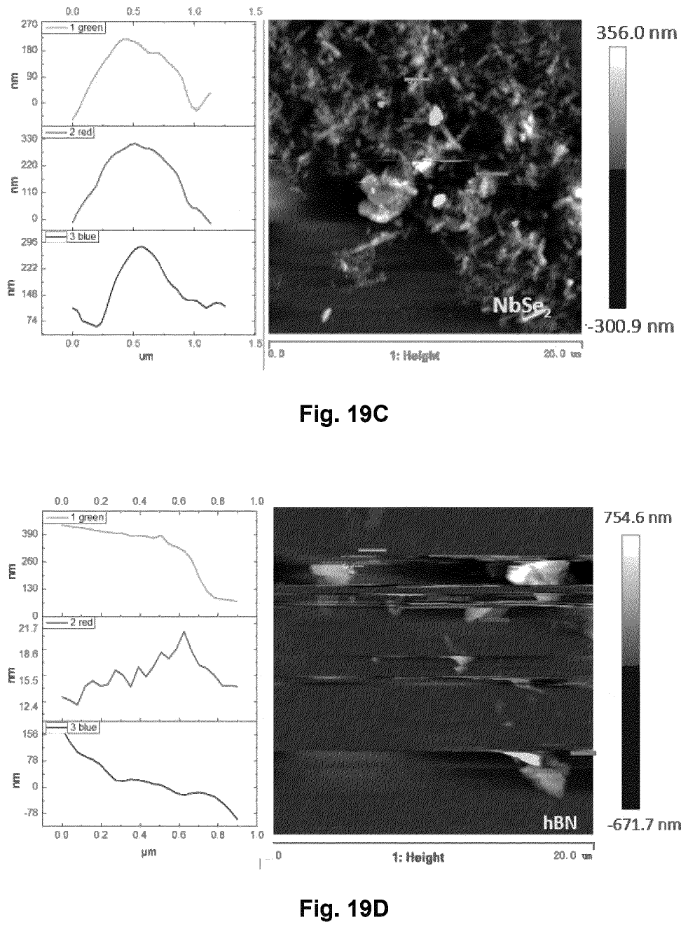

FIGS. 19A to 19D show AFM images and line scans for 10V 2 h deposition. The height range of MoSe₂ and WSe₂ are 254 nm and 209.3 nm respectively. These images further confirm that hBN deposits poorly. Roughness data is shown below in Table 3, again noting that Rₐ roughness is expected for be high for a patchy deposition.

TABLE 3
Sample roughness.

| Material | Roughness Rₐ (nm) |
|---|---|
| MoSe₂ | 25.8 |
| WSe₂ | 22.7 |

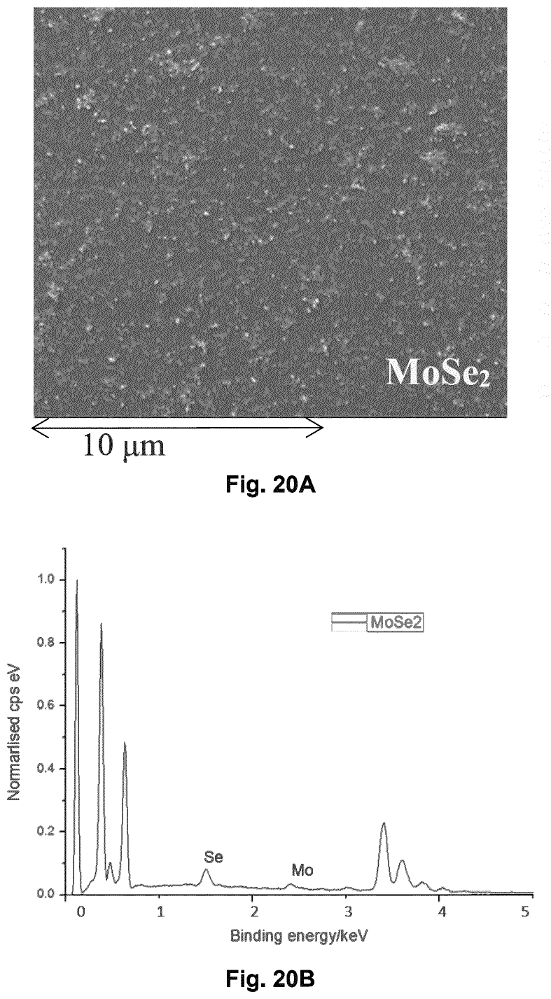

FIGS. 20A to 20B show SEM EDS data for MoSe₂.

TABLE 4
Elemental composition ratio.
MoSe₂
Mo: 1.9
Se: 2.6

From FIGS. 20A to 20B and Table 4 we can find that the ratio of MoSe₂ is close to 1:2, with the flakes being spread evenly across the surface. It was not possible to gather SEM measurements of other coatings under these deposition conditions.

Deposition Conditions: 10V 3 h

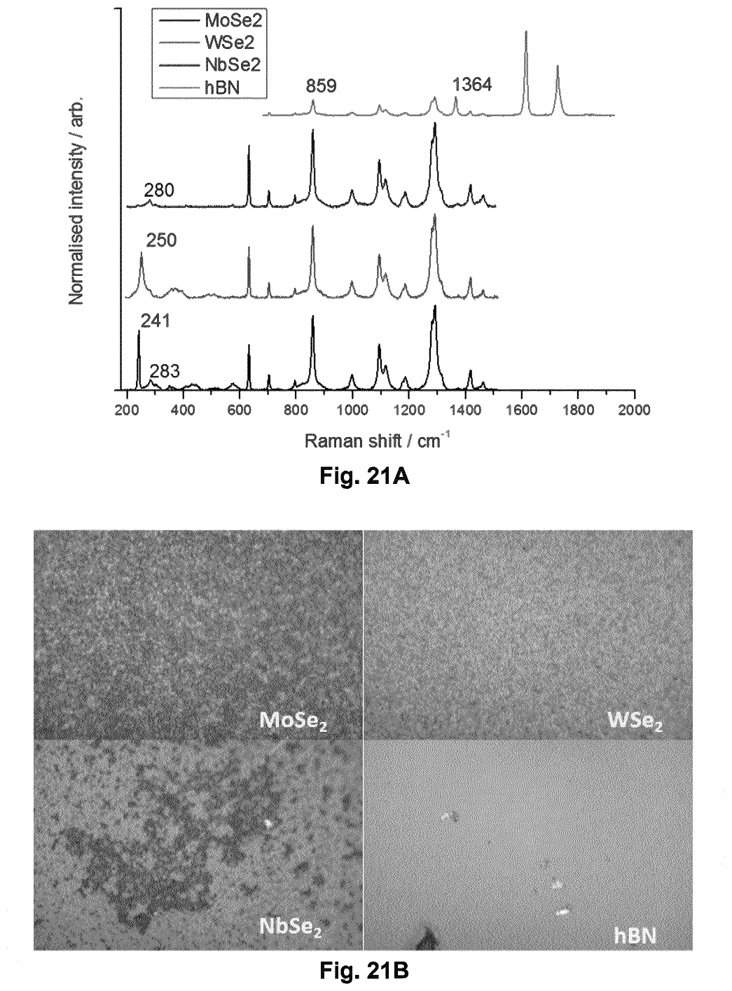

FIGS. 21A and 21B show Raman shift and Raman microscope images for 10V 3 h deposition, for 2D materials according to exemplary embodiments. WSe₂ and MoSe₂ show peaks at 250 cm⁻¹ and 241 cm⁻¹ respectively, the peak of hBN is at 1364 cm⁻¹, with all results similar to deposition at 10V 1 h. The intensity of hBN and NbSe₂ are weak suggesting low concentration for the deposition.

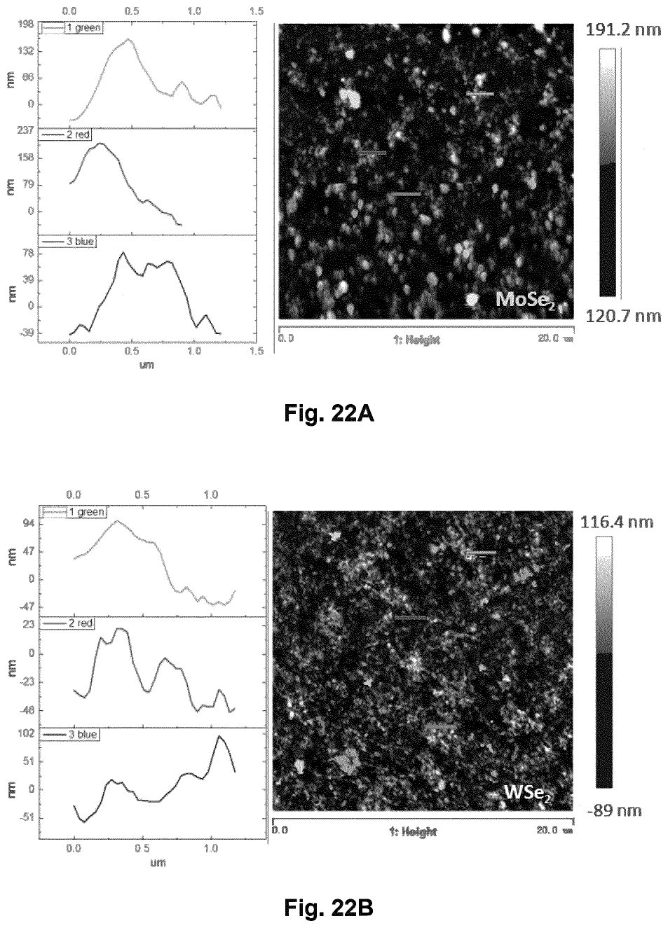

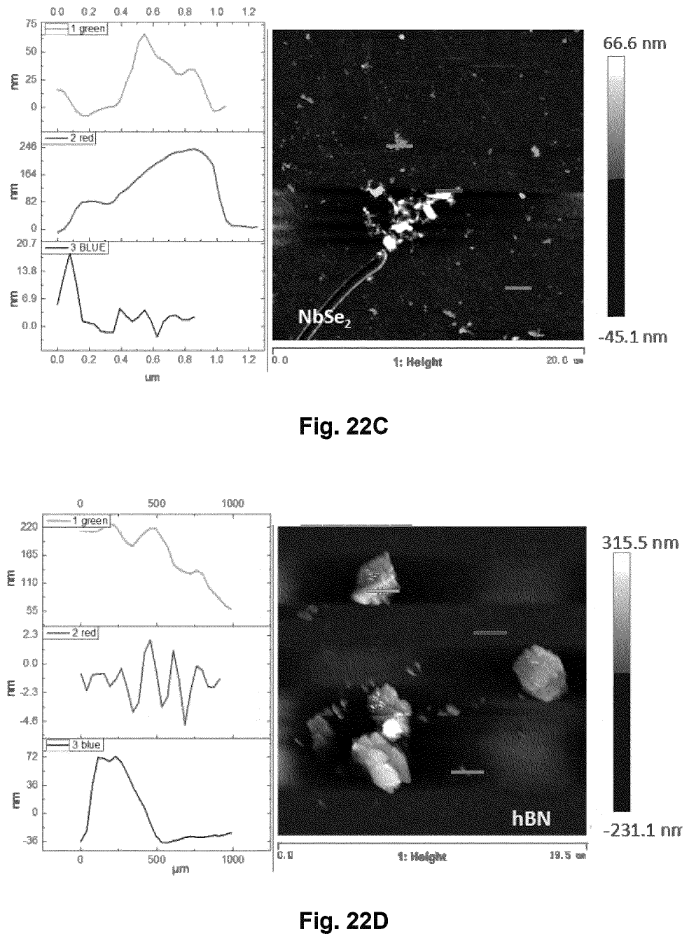

FIGS. 22A to 22D show AFM images and typical line traces for 10V 3 h deposition, for 2D materials according to exemplary embodiments, with Table 5 showing Rₐ roughness values.

TABLE 5
Sample roughness.

| Material | Roughness Rₐ (nm) |
|---|---|
| MoSe₂ | 33.4 |
| WSe₂ | 22.8 |

TABLE 6
Elemental composition ratio.

| MoSe₂ | WSe₂ |
|---|---|
| Mo: 2.6 | W: 11 |
| Se: 4.0 | Se: 8.9 |

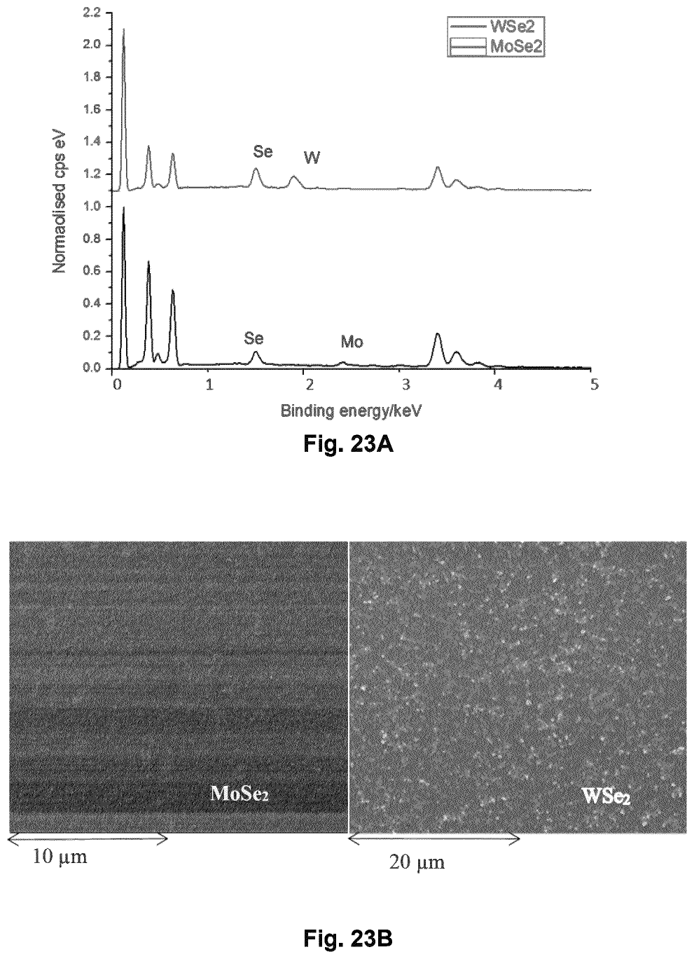

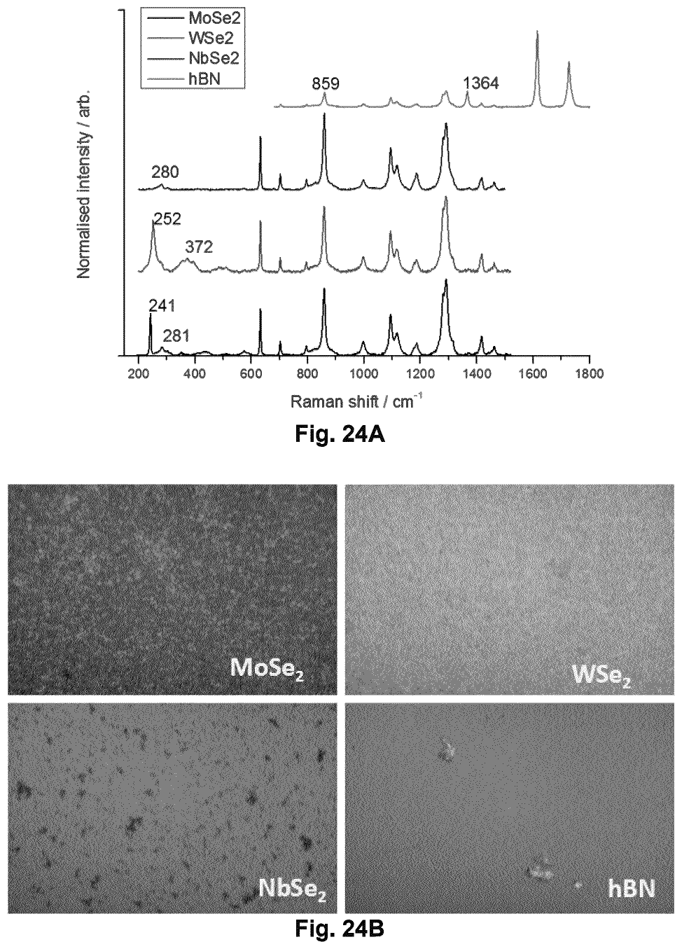

From FIGS. 23A to 23B and Table 6, the ratio of MoSe₂ and WSe₂ are close to the ratio of 1:2. NbSe₂ and hBN were not able to be measured by SEM EDS under these conditions. Based on the results of 10V 1 hour, another attempt was made applying higher voltage to provide a greater electric field and so more electrophoretic force to move the nanoparticles. So, we choose 15V and 20V as the test voltage since high voltage may cause oxidation.

Deposition Conditions: 15 V 1 h

FIGS. 24A to 24B show Raman shift and Raman microscope images for 15V 1 h deposition, for 2D materials according to exemplary embodiments. It can be seen from the diagram that for MoSe₂ and WSe₂ the peaks at 241 cm⁻¹ and 252 cm⁻¹ in order, with intensity similar to deposition at 10V 1 h. The peaks of hBN and NbSe₂ are 1364 cm⁻¹ and 280 cm⁻¹ respectively. The intensity of hBN and NbSe₂ peaks are weak suggesting the concentrations are low. As can be seen from the microscope pictures, MoSe₂ and WSe₂ show even deposition. However, NbSe₂ and hBN coatings are still patchy.

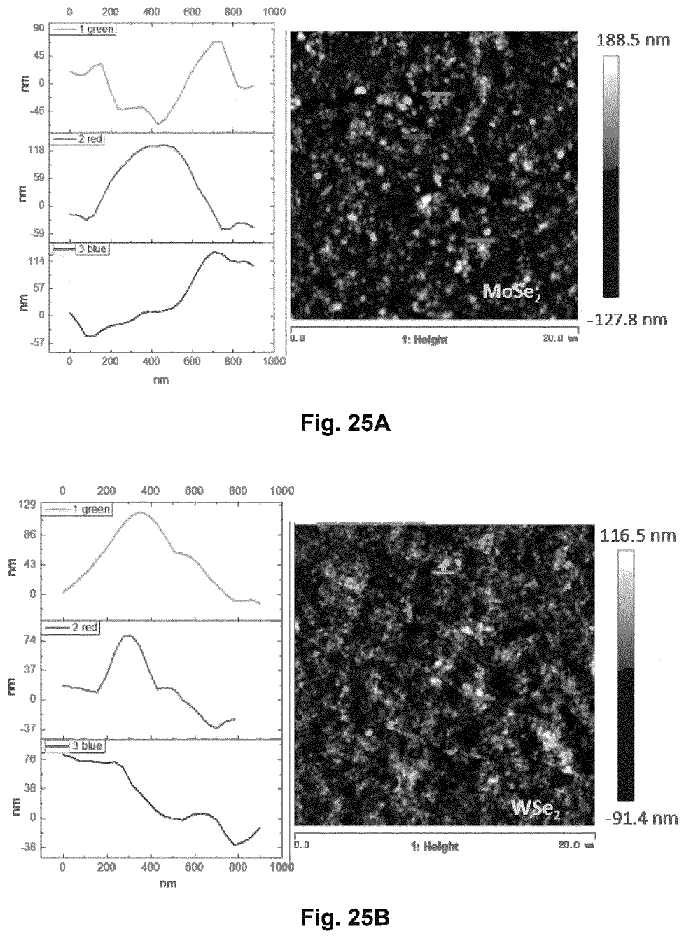

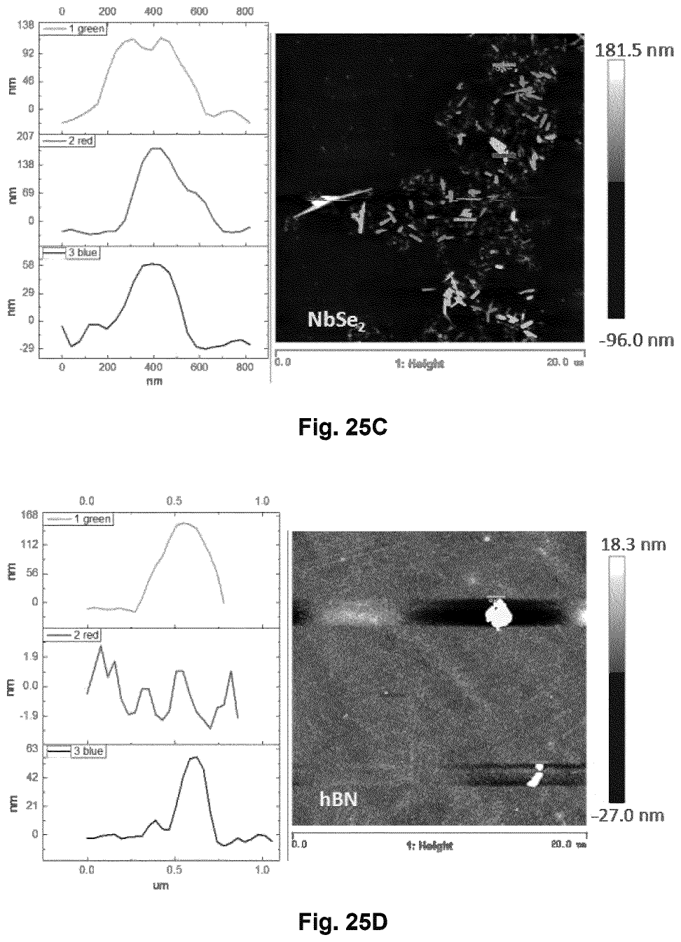

FIGS. 25A to 25D show AFM images and typical line scans for 15V 1 h deposition, for 2D materials according to exemplary embodiments.

TABLE 7
Sample roughness.

| Material | Roughness Rₐ (nm) |
|---|---|
| MoSe₂ | 35.1 |
| WSe₂ | 23.2 |

Deposition Conditions: 20V 1 h

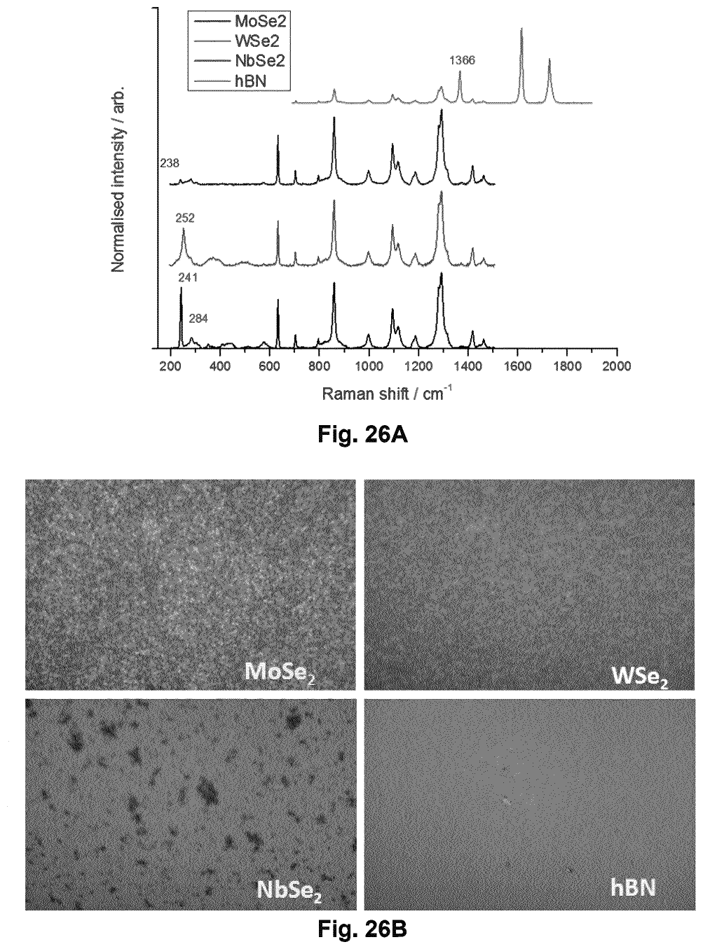

FIGS. 26A to 26B show Raman shift and Raman microscope images for 20V 1 h deposition, for 2D materials according to exemplary embodiments. The peak of WSe₂ and MoSe₂ are 252 cm⁻¹ and 241 cm⁻¹ respectively. The identity of the peak between 284 cm⁻¹ and 304 cm⁻¹ for MoSe₂ still needs further confirmation, but is not thought to be due to oxidation. The microscope pictures show the MoSe₂ and WSe₂ have good deposition. Compare to 10V, 1 h, hBN does not show a good deposition since the material is highly patchy.

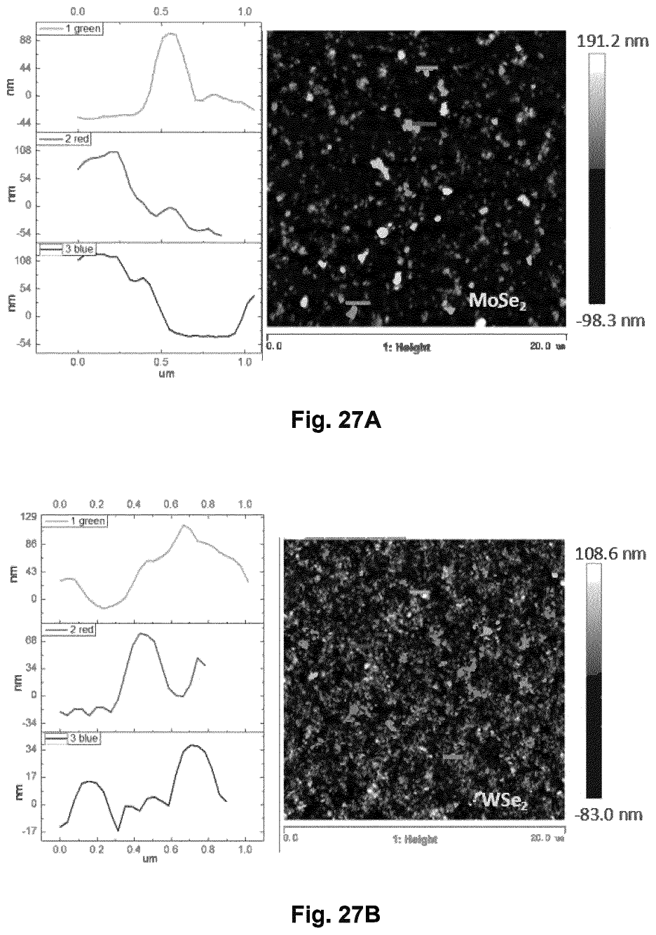

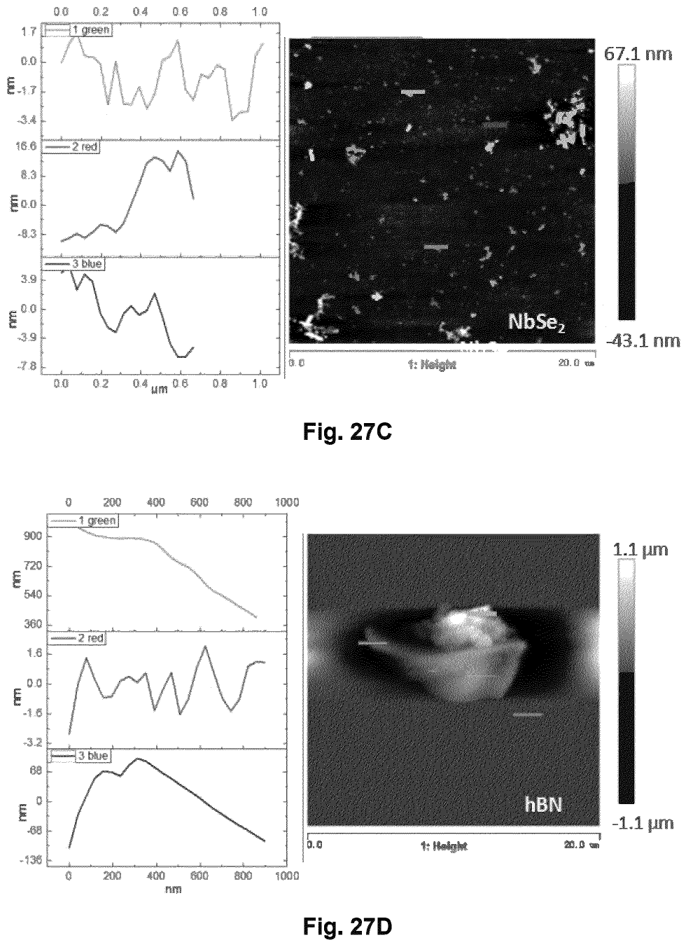

FIGS. 27A to 27D show AFM images and line scans for 20V 1 h deposition, for 2D materials according to exemplary embodiments.

TABLE 8
Sample roughness.

| Material | Roughness Rₐ (nm) |
|---|---|
| MoSe₂ | 36.6 |
| WSe₂ | 21.4 |

Post-Deposition Bake

To predict the statues of coatings after suffering space environment, we use a vacuum thermal chamber to test the coatings. Due to the time limitation, we only test the 10V 1 h sample.

Table 9 shows the maximum temperature (1) and minimum pressure (2) in the vacuum chamber when simulating the space environment.

TABLE 9
Pressures and temperatures in vacuum chamber.

| | | Current | Temperature |
|---|---|---|---|
| | Pressure (mbar) | (A) | (° C.) |
| 1 | 5.77 × 10⁻⁷ | 1.152 | 101.2 |
| 2 | 9.38 × 10⁻⁷ | 0.902 | 23 |

These temperature data attempt to simulate part of space temperature and pressure, meanwhile, it can clean the surface of the coatings for the further research.

Raman, AFM, SEM EDS were used to characterize the coatings again after this thermal vacuum bake out.

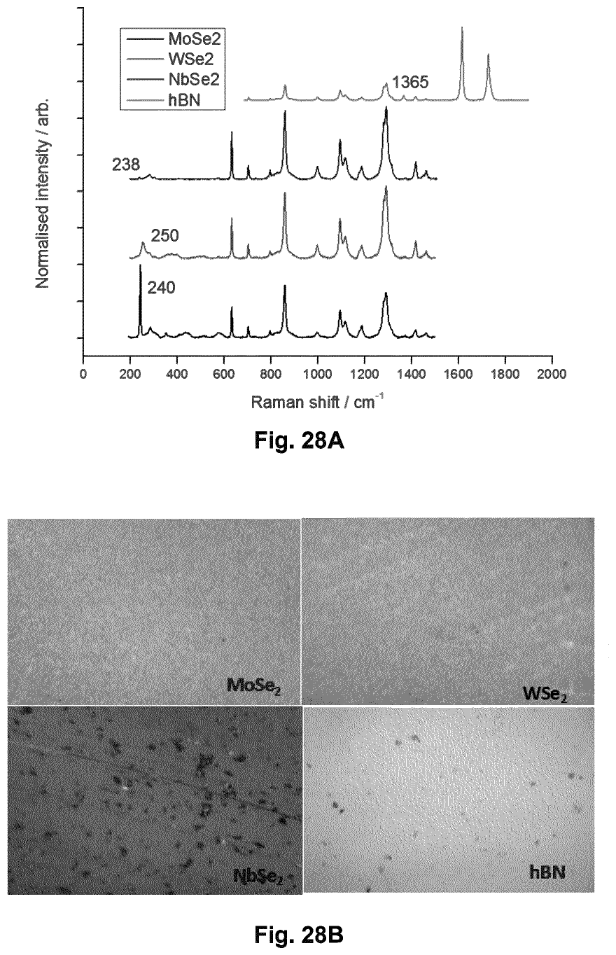

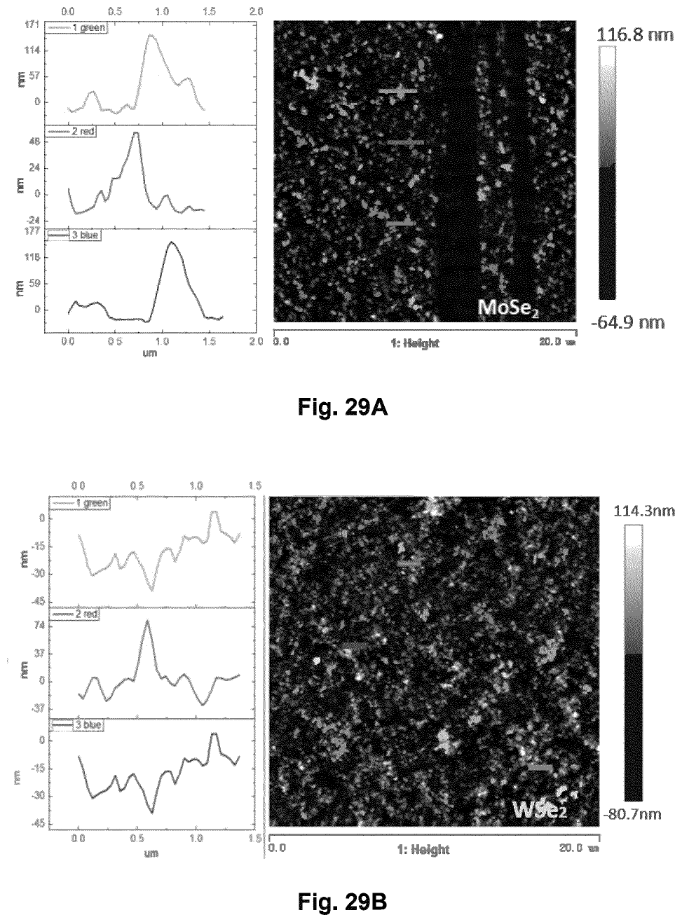

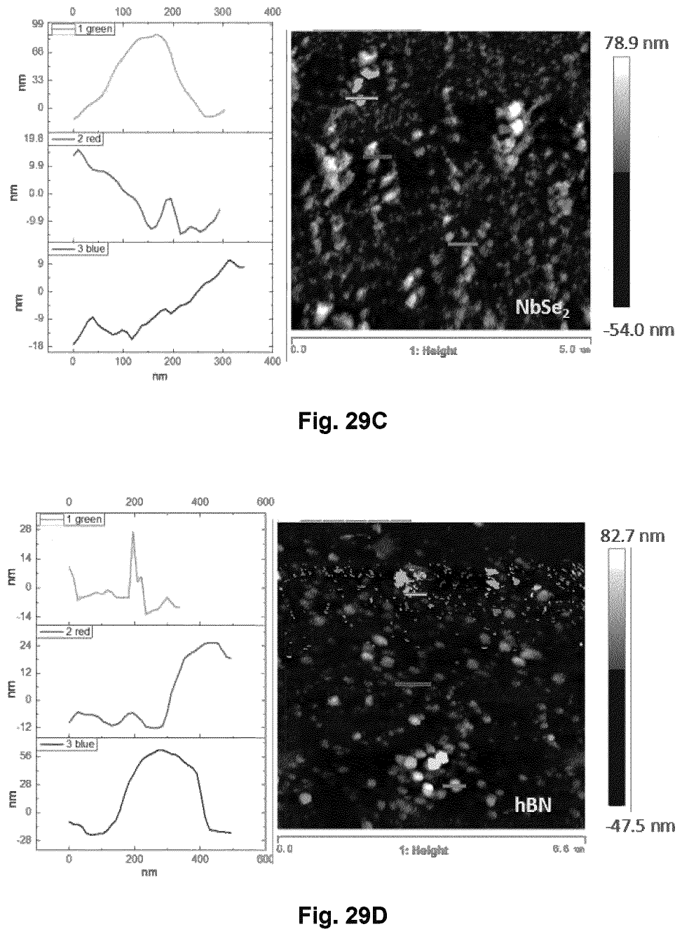

FIGS. 28A to 28B show Raman shift and Raman microscope images for 10V 1 h deposition after baking, for 2D materials according to exemplary embodiments. After the testing, these materials show stable properties and very similar morphology to that before baking. FIGS. 29A to 29D show AFM images and line scans for 10V 1 h deposition after baking, for 2D materials according to exemplary embodiments.

TABLE 10
Sample roughness.

| Material | Roughness Rₐ (nm) |
|---|---|
| MoSe₂ | 17.4 |
| WSe₂ | 21.6 |

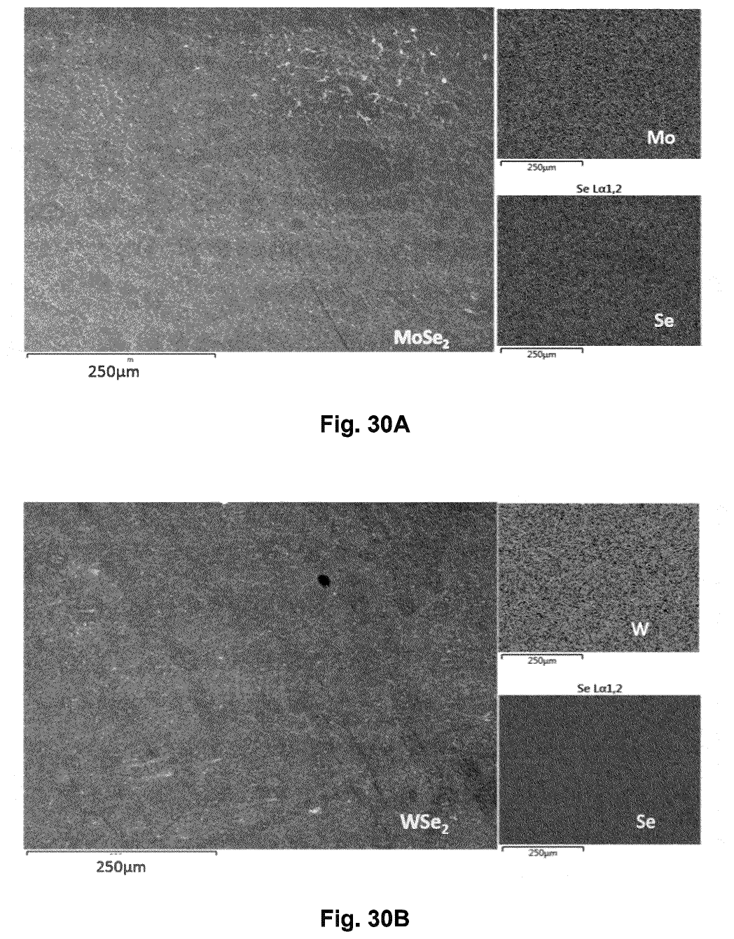

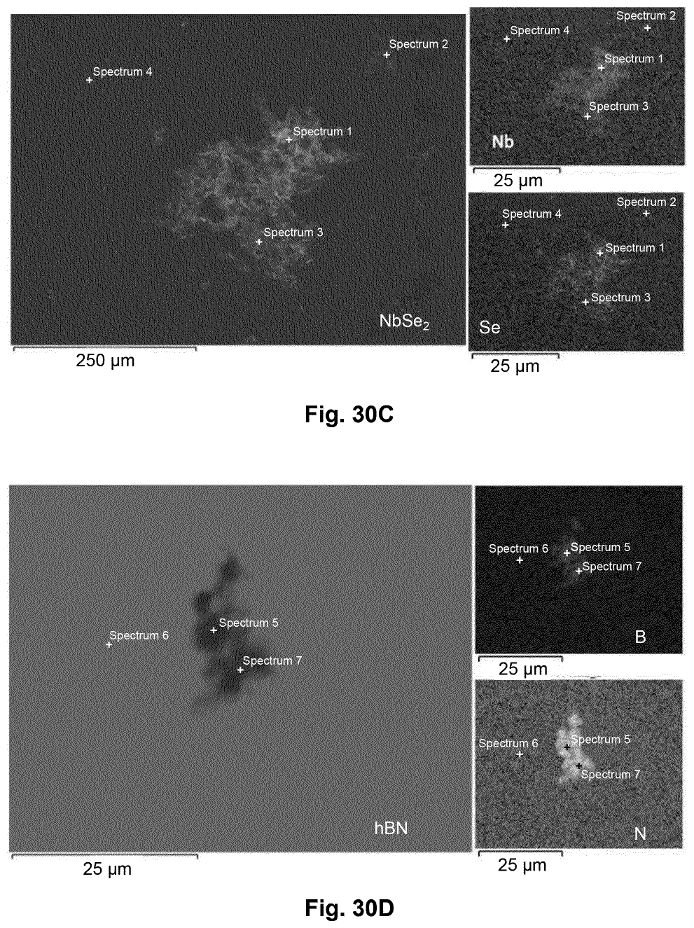

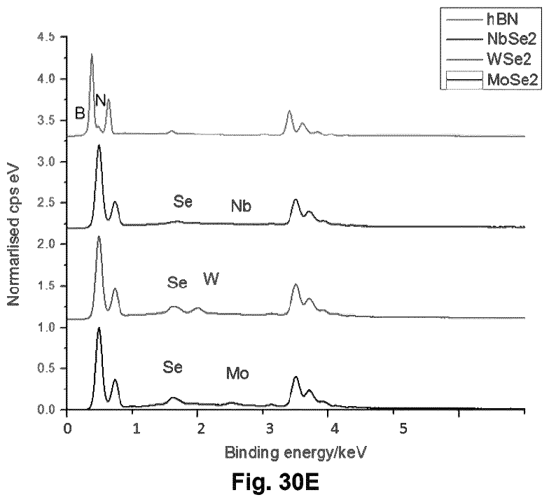

FIGS. 23A to 30E show SEM EDS data for 10V 1 h deposition after baking, for 2D materials according to exemplary embodiments.

TABLE 11
Elemental composition ratio.

| MoSe₂ | WSe₂ | NbSe₂ | hBN |
|---|---|---|---|
| Mo: 0.8 | W: 2.2 | Nb: 0.2 | B: 3.1 |
| Se: 1.8 | Se: 1.7 | Se: 0.2 | N: 2.1 |

The MoSe₂ is roughly close to the 1:2, whereas other samples show unexpected element ratios. Raman spectra show no unexpected features. The effect of low pressure baking on these coatings needs to be further studied.

### Results Summary

In summary, among all these deposition conditions, MoSe₂ and WSe₂ show consistency good coating results, but NbSe₂ and hBN are inconsistent, with hBN typically producing poor coatings. A possible reason is that hBN and NbSe₂ have large particle size that are a result of incomplete exfoliatation.

The most likely condition to produce best quality deposition by electrophoretic is under 10V 3 hours from 50% power 1 g/100 ml dispersion.

Although a preferred embodiment has been shown and described, it will be appreciated by those skilled in the art that various changes and modifications might be made without departing from the scope of the invention, as defined in the appended claims and as described above.

### SUMMARY

In order to realize the significant commercial desire for sustained satellite operation in VLEO, improved coating materials capable of minimizing atmospheric drag or improving aerodynamic lift production are a necessity. Such materials will need to combine both excellent atomic oxygen erosion resistance properties and atomic oxygen reflection properties. The fundamental material properties necessary to achieve these aims have been discussed in detail and the significant body of literature on the utilization of oxides in various forms as coatings to protect against erosion by atomic oxygen has been reviewed. The lack of significant literature into the atomic oxygen reflection properties of these coating materials is notable. Particularly as the limited results that have been obtained have led to the identification of layered van der Waals materials as the ideal surface structure for obtaining excellent atomic reflection properties. Despite their phenomenal atomic reflection properties, carbon based graphitic materials would appear to not be suitable for use in VLEO due to their well characterized chemical reactions with atomic oxygen, producing volatile oxide products that lead to the significant erosion and roughening of these materials. In comparison, hBN and MoSe₂ have shown initial promise in combining the excellent atomic oxygen reflection properties of graphene with improved erosion resistance, whilst more novel, and as yet uninvestigated 2D materials may show even better performance.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A spacecraft or a part thereof having a coating comprising a 2D material on an outer surface thereof,
wherein the 2D material comprises one or more elements, excluding C, N and S, in an amount of at least 50 at. %; and
wherein respective oxides of the one or more elements of the 2D material have a vapour pressure of at most 10 Pa at a temperature of 323 K.

2. The spacecraft or a part thereof according to claim 1, wherein the 2D material comprises the one or more elements, excluding C, N and S, in an amount of at least 66 at. %.

3. The spacecraft or a part thereof according to claim 1, wherein the 2D material is a transition metal dichalcogenide, TMD, having a chemical formula MX2, wherein M is a transition metal and X is a chalcogen.

4. The spacecraft or a part thereof according to claim 3, wherein X is Se or Te.

5. The spacecraft or a part thereof according claim 3, wherein M is a group 5 transition metal or a group 6 transition metal.

6. The spacecraft or a part thereof according to claim 4, wherein the TMD is MoSe₂, WSe2 or NbSe₂, preferably MoSe₂ or WSe2.

7. The spacecraft or a part thereof according to claim 1, wherein the 2D material comprises flakes thereof, having a dimension, transverse to a thickness thereof, in a range from 5 nm to 390 nm, preferably in a range from 10 nm to 200 nm, more preferably in a range from 15 nm to 100 nm.

8. The spacecraft a or a part thereof according to claim 7, wherein the coating has a roughness average R_a in a range from 0 nm to 50 nm, preferably in a range from 10 nm to 40 nm, more preferably in a range from 15 nm to 35 nm.

9. (canceled)

10. A method of protecting, at least in part, a spacecraft, for example a satellite such as a Very Low Earth Orbit, VLEO, satellite, or a part thereof according to claim 1, the method comprising:
exposing the coating to atomic oxygen incident thereupon, reacting the one or more elements of the 2D material with the atomic oxygen and producing respective oxides of the one or more elements.

11. A method of providing a coating on a substrate for a spacecraft, for example a satellite, or a part thereof, the method comprising:
providing a 2D material, for example by liquid phase exfoliation, LPE; and
depositing the 2D material on the substrate, for example by electrophoretic deposition, EPD, thereby providing the coating on the substrate;
optionally wherein the 2D material is a transition metal dichalcogenide, TMD, having a chemical formula MX2, wherein M is a transition metal, preferably a second row or a third row transition metal, and X is a chalcogen.

12. The method according to claim 11, wherein providing the 2D material by LPE comprises dispersing a 2D material precursor in a liquid phase, exfoliating the 2D material precursor dispersed in the liquid phase, for example by sonication, and purifying the exfoliated 2D material, for example by centrifugation, thereby providing the 2D material.

13. The method according to claim 12, wherein exfoliating the 2D material precursor dispersed in the liquid phase by sonication comprises sonicating the 2D material precursor dispersed in the liquid phase at a power in a range from 25 W to 1 kW, preferably in a range from 50 W to 500 W, more preferably in a range from 75 W to 150 W, for example 100 W, 110 W or 120 W for 1 g of the 2D material precursor dispersed in 100 ml of the liquid phase, optionally at a frequency in a range from 20 kHz to 1174 kHz, preferably in a range from 25 kHz to 100 kHz, more preferably in a range from 30 kHz to 50 kHz, for example 35 kHz, 37 kHz or 40 kHz, optionally for a duration in a range from 0.5 hours to 12 hours, preferably in a range from 2 hours to 6 hours, for example 4 hours, optionally at a temperature in a range from 283 K to 313 K, preferably in a range from 288 K to 303 K.

14. The method according to claim 11, wherein the 2D material comprises flakes thereof, having a dimension, transverse to a thickness thereof, in a range from 5 nm to 390 nm, preferably in a range from 10 nm to 200 nm, more preferably in a range from 15 nm to 100 nm.

15. The method according to claim 11, wherein depositing the 2D material on the substrate by EPD comprises preparing a suspension of the 2D material, immersing the substrate in the suspension and applying a voltage in a range between 5 V and 30 V, preferably between 10 V and 20 V between the immersed substrate and a counter electrode.

16. The method according to claim 15, wherein applying the voltage comprises applying the voltage for a duration in a range from 0.5 hours to 6 hours, preferably in a range from 1 hour to 3 hours.

17. (canceled)

18. The spacecraft or a part thereof according to claim 1, wherein the spacecraft is a satellite.

19. The spacecraft or a part thereof according to claim 2, wherein the 2D material comprises the one or more elements, excluding C, N and S, in an amount of at least 75 at.%.

20. The spacecraft or a part thereof according to claim 3, wherein M is a second row or a third row transition metal.

21. The spacecraft or a part thereof according to claim 4, wherein M is Nb or Ta.

22. The spacecraft or a part thereof according to claim 4, wherein M is Mo or W.
